(19) United States
(12) Patent Application Publication
(10) Pub. No.: US 2017/0019163 A1
(43) Pub. Date: Jan. 19, 2017

(54) TERMINAL APPARATUS AND BASE STATION APPARATUS

(71) Applicant: SHARP KABUSHIKI KAISHA, Sakai City, Osaka (JP)

(72) Inventors: Takashi YOSHIMOTO, Sakai City, Osaka (JP); Ryota YAMADA, Sakai City, Osaka (JP)

(73) Assignee: SHARP KABUSHIKI KAISHA, Sakai City, Osaka (JP)

(21) Appl. No.: 15/124,593

(22) PCT Filed: Mar. 16, 2015
(86) PCT No.: PCT/JP2015/057680

§ 371 Date: Sep. 8, 2016

(30) Foreign Application Priority Data
Mar. 20, 2014 (JP) 2014-057385

(51) Int. Cl. H04B 7/06; H04L 5/00; H04W 24/10

(52) U.S. Cl. CPC H04B 7/0665; H04W 24/10; H04L 5/0035; H04B 7/0697; H04B 7/0626; H04W 88/08

(57) ABSTRACT

A terminal apparatus and a base station apparatus are provided that make it possible to efficiently report reception quality information in transmitting the reception quality information. The terminal apparatus includes a transmitting unit that transmits channel state information report feedback constituted by a given number of channel state information values corresponding to information pertaining to a network assisted interference cancellation function and a channel state information request. Channel state information values corresponding to a mode configuration in which channel state information is periodically reported are channel state information values that are suitable in a case of reception of a downlink signal without application of the network assisted interference cancellation function. Channel state information values that are suitable in a case of reception of a downlink signal with application of the network assisted interference cancellation function are channel state information values that are transmitted in a mode configuration in which channel state information is aperiodically reported.

### TECHNICAL FIELD

The present invention relates to a terminal apparatus and a base station apparatus.

### BACKGROUND ART

In a communication system such as WCDMA (registered trademark) (Wideband Code Division Multiple Access), LTE (Long Term Evolution), or LTE-A (LTE-Advanced), which are standardized by the 3GPP (Third Generation Partnership Project), or WiMAX (Worldwide Interoperability for Microwave Access), an expansion in communication area can be achieved by a cellular configuration in which a plurality of areas each covered by a base station apparatus (base station, transmitting station, transmitting point, downlink transmitting apparatus, uplink receiving apparatus, group of transmitting antennas, group of transmitting antenna ports, component carrier, eNodeB) or a transmitting station equivalent to the base station apparatus are arranged in the form of cells. In this cellular configuration, an improvement in efficiency in the use of frequencies can be achieved by utilizing the same frequency between neighboring cells or sectors.

However, in such a cellular configuration, a terminal apparatus (mobile station apparatus, receiving station, receiving point, uplink transmitting apparatus, downlink receiving apparatus, mobile terminal, group of receiving antennas, group of receiving antenna ports, UE; user equipment) located in a cell edge region or a sector edge region is subjected to interference from a transmitted signal from a base station apparatus constituting another cell or another sector (inter-cell interference, inter-sector interference). This undesirably reduces the efficiency in the use of frequencies.

Measures are taken against inter-cell interference or inter-sector interference by advancing the reception capability of a terminal apparatus (advanced receiver). For example, NPL 1 discloses an MMSE-IRC (minimum mean square error-interference rejection combining) receiver, an interference cancellation receiver, an interference suppression receiver, an MLD (maximal likelihood detection) receiver, and the like as such advanced receivers. This makes it possible to ease restrictions imposed by inter-cell interference or the like, thus making it possible to improve the efficiency in the use of frequencies.

The communication system applies spatial multiplex transmission (MIMO; multiple-input and multiple-output) in order to achieve efficient data transmission. The advanced receiver can improve the efficiency in the use of frequencies by being used to suppress inter-stream interference (inter-layer interference, inter-antenna interference) generated in spatial multiplex transmission.

### CITATION LIST

### Non Patent Literature

NPL 1: “Study on Network Assisted Interference Cancellation and Suppression for LTE,” 3GPP TSG RAN Meeting #59, RP-130404, March 2013.

NPL 2: 3rd Generation Partnership Project; Technical Specification Group Radio Access Network; Evolved Universal Terrestrial Radio Access (E-UTRA); Physical layer procedures (Release 11), September 2013, 3GPP TS36.213 V11.4.0 (2013-09).

NPL 3: 3rd Generation Partnership Project; Technical Specification Group Radio Access Network; Evolved Universal Terrestrial Radio Access (E-UTRA); Radio Resource Control (RRC); Protocol specification (Release 11), September 2013, 3GPP TS36.331 V11.5.0 (2013-09).

### SUMMARY OF INVENTION

### Technical Problem

In a communication system, a modulation scheme and a code rate (MCS; modulation and coding scheme) and a spatial multiplexing order (number of layers, rank) are adaptively controlled according to the state of a channel between a base station apparatus and a terminal apparatus so that efficient data transmission can be achieved. These control methods are disclosed in NPL 2 and NPL 3.

For example, in a case where, in LTE, the MCS, spatial multiplexing order, and the like of a downlink transmission signal (e.g. a PDSCH (physical downlink shared channel)) that is transmitted through a downlink are adaptively controlled, a terminal apparatus calculates reception quality information (also referred to as “channel state information (CSI)”) with reference to a downlink reference signal (DLRS) contained in a downlink transmission signal transmitted from a base station apparatus and reports the reception quality information to the base station apparatus via an uplink channel (e.g. a PUCCH). The base station apparatus selects an MCS and a spatial multiplexing order in consideration of the reception quality information or the like transmitted by the terminal apparatus, applies the MCS and the spatial multiplexing order to a downlink transmission signal, and transmits the downlink transmission signal. The reception quality information corresponds to a rank indicator RI that indicates a preferred spatial multiplexing order, a precoding matrix indicator PMI that indicates a preferred precoder, a channel quality indicator CQI that indicates a preferred transmission rate, and the like.

It is desirable that, in a terminal apparatus, the preferred MCS and the like vary depending on whether the terminal apparatus applies advanced reception. Further, whether to apply advanced reception is considered to be selected according to the properties of interference from another cell (e.g. the MCS and spatial multiplexing order of an interfering signal). For this reason, it is desirable that the terminal apparatus transmit both an MCS and the like that are suitable in a case where advanced reception is applied and an MCS and the like that are suitable in a case where advanced reception is not applied. However, transmitting both the MCSs and the like poses a problem of requiring more resources for reception quality information (CSI feedback, CSI report) that the terminal apparatus transmits to the base station apparatus.

The present invention has been made in view of the foregoing problems and has as an object to provide a terminal apparatus and a base station apparatus that make it possible to efficiently report reception quality information in transmitting the reception quality information.

### Solution to Problem

In order to solve the problems described above, a terminal apparatus and a base station apparatus according to the present invention are configured as follows:

(1) A terminal apparatus according to an aspect of the present invention is a second terminal apparatus in a communication system constituted by a base station apparatus that controls a first terminal apparatus and the second terminal apparatus, which has a more advanced reception function than the first terminal apparatus, the second terminal apparatus including: a receiving unit that receives information pertaining to the advanced reception function, a channel state information request, and information pertaining to a channel state information report configuration; and a transmitting unit that transmits channel state information report feedback constituted by a given number of channel state information values corresponding to the information pertaining to the channel state information report configuration and the channel state information request, wherein the information pertaining to the channel state information report configuration includes a mode configuration in which channel state information is periodically reported and a mode configuration in which channel state information is aperiodically reported, channel state information values corresponding to the mode configuration in which channel state information is periodically reported are channel state information values that are suitable in a case of reception of a downlink signal without application of the advanced reception function, and channel state information values that are suitable in a case of reception of a downlink signal with application of the advanced reception function are channel state information values that are transmitted in the mode configuration in which channel state information is aperiodically reported.

(2) Further, a terminal apparatus according to an aspect of the present invention is the terminal apparatus described above, wherein in a case where the information pertaining to the advanced reception function is information indicating that the advanced reception function is applied, channel state information values corresponding to the mode configuration in which channel state information is aperiodically reported are channel state information values that are suitable in the case of reception of a downlink signal with application of the advanced reception function.

(3) Further, a terminal apparatus according to an aspect of the present invention is the terminal apparatus described above, wherein in a case where the information pertaining to the advanced reception function is information indicating that the advanced reception function is not applied and where the mode configuration in which channel state information is periodically reported is a mode in which wideband channel state information is reported, channel state information values corresponding to the mode configuration in which channel state information is aperiodically reported are selected from among either channel state information values that are suitable in the case of reception of a downlink signal without application of the advanced reception function or the channel state information values that are suitable in the case of reception of a downlink signal with application of the advanced reception function.

(4) Further, a terminal apparatus according to an aspect of the present invention is the terminal apparatus described above, wherein the channel state information request contains instructions for a request for the channel state information values that are suitable in the case of reception of a downlink signal without application of the advanced reception function and a request for the channel state information values that are suitable in the case of reception of a downlink signal with application of the advanced reception function, and the channel state information values corresponding to the mode configuration in which channel state information is aperiodically reported are selected according to the channel state information request.

(5) Further, a terminal apparatus according to an aspect of the present invention is the terminal apparatus described above, wherein in a case where the information pertaining to the advanced reception function is information indicating that the advanced reception function is not applied and where the mode configuration in which channel state information is periodically reported is a mode in which narrowband channel state information is reported, the channel state information values corresponding to the mode configuration in which channel state information is aperiodically reported are the channel state information values that are suitable in the case of reception of a downlink signal with application of the advanced reception function.

(6) Further, a terminal apparatus according to an aspect of the present invention is the terminal apparatus described above, wherein the receiving unit receives information indicating a scheme for modulating an interfering signal, the terminal apparatus further including a signal detection unit that cancels or suppresses the interfering signal with use of the information indicating the scheme for modulating the interfering signal.

(7) Further, a terminal apparatus according to an aspect of the present invention is the terminal apparatus described above, wherein the receiving unit receives information indicating a rank of an interfering signal, the terminal apparatus further including a signal detection unit that demultiplexes a spatially multiplexed signal with use of the information indicating the rank of the interfering signal.

(8) A base station apparatus according to an aspect of the present invention is a base station apparatus that controls a first terminal apparatus and a second terminal apparatus having a more advanced reception function than the first terminal apparatus, the base station apparatus including: a transmitting unit that transmits information pertaining to the advanced reception function, a channel state information request, and information pertaining to a channel state information report configuration; and a receiving unit that receives channel state information report feedback constituted by a given number of channel state information values corresponding to the information pertaining to the channel state information report configuration and the channel state information request, wherein the information pertaining to the channel state information report configuration includes a mode configuration in which channel state information is periodically reported and a mode configuration in which channel state information is aperiodically reported, channel state information values corresponding to the mode configuration in which channel state information is periodically reported are channel state information values that are suitable in a case of reception of a downlink signal without application of the advanced reception function, and channel state information values that are suitable in a case of reception of a downlink signal with application of the advanced reception function are channel state information values that are transmitted in the mode configuration in which channel state information is aperiodically reported.

(9) Further, a terminal apparatus according to an aspect of the present invention is the terminal apparatus described above, wherein in a case where the information pertaining to the advanced reception function is information indicating that the advanced reception function is applied, channel state information values corresponding to the mode configuration in which channel state information is aperiodically reported are the channel state information values that are suitable in the case of reception of a downlink signal with application of the advanced reception function.

(10) Further, a terminal apparatus according to an aspect of the present invention is the terminal apparatus described above, wherein in a case where the information pertaining to the advanced reception function is information other than information indicating that the advanced reception function is applied and where the mode configuration in which channel state information is periodically reported is a mode in which wideband channel state information is reported, the channel state information request contains instructions for a request for the channel state information values that are suitable in the case of reception of a downlink signal without application of the advanced reception function and a request for the channel state information values that are suitable in the case of reception of a downlink signal with application of the advanced reception function.

(11) Further, a terminal apparatus according to an aspect of the present invention is the terminal apparatus described above, wherein in a case where the information pertaining to the advanced reception function is information other than information indicating that the advanced reception function is applied and where the mode configuration in which channel state information is periodically reported is a mode in which narrowband channel state information is reported, channel state information values corresponding to the mode configuration in which channel state information is aperiodically reported are the channel state information values that are suitable in the case of reception of a downlink signal with application of the advanced reception function.

### Advantageous Effects of Invention

The present invention makes it possible to efficiently report reception quality information in transmitting the reception quality information.

### BRIEF DESCRIPTION OF DRAWINGS

FIG. 1 is a schematic view showing a configuration of a communication system.

FIG. 2 is a diagram schematically showing a configuration of a radio frame.

FIG. 3 is a diagram showing an example of the allocation of physical channels and physical signals in a downlink subframe.

FIG. 4 is a diagram showing an example of the allocation of physical channels and physical signals in an uplink subframe.

FIG. 5 is a diagram showing an example of calculation of narrowband CSI.

FIG. 6 is a diagram showing another example of calculation of narrowband CSI.

FIG. 7 is a diagram showing a sequence in the case of aperiodic reporting of channel state information.

FIG. 8 is a diagram showing a sequence in the case of periodic reporting of channel state information.

FIG. 9 is a block diagram schematically showing a configuration of a base station apparatus.

FIG. 10 is a block diagram schematically showing a terminal apparatus including an advanced reception function.

### DESCRIPTION OF EMBODIMENTS

An embodiment according to the present invention is described below with reference to the drawings.

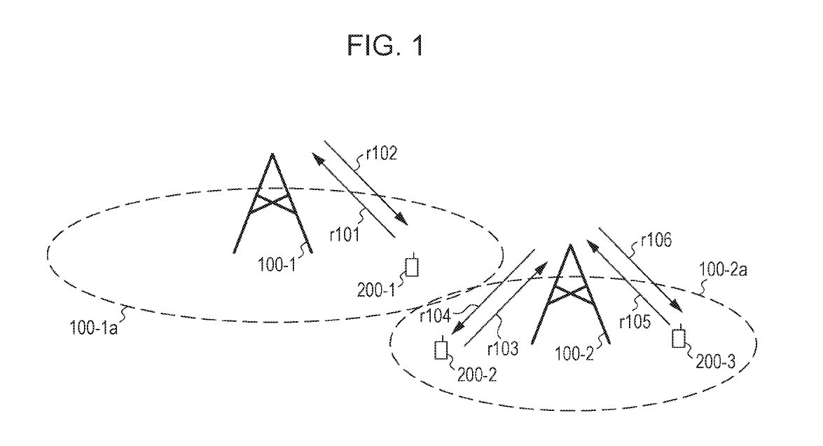

FIG. 1 is a schematic view showing a configuration of a communication system according to the present embodiment. The communication system of FIG. 1 is an example constituted by base station apparatuses 100-1 and 100-2 (base stations, transmitting stations, transmitting points, downlink transmitting apparatuses, uplink receiving apparatuses, groups of transmitting antennas, groups of transmitting antenna ports, component carriers, eNodeB) and terminal apparatuses 200-1, 200-2 and 200-3 (mobile station apparatuses, receiving stations, receiving points, uplink transmitting apparatuses, downlink receiving apparatuses, mobile terminals, groups of receiving antennas, groups of receiving antenna ports, UE; user equipment). The terminal apparatus 200-1 is connected to the base station apparatus 100-1, which has a connectable range (cell, component carrier) 100-1a. The terminal apparatuses 200-2 and 200-3 are connected to the base station apparatus 100-2, which has a connectable range (cell) 100-2a.

In the present embodiment, “X/Y” encompasses the meaning of “X or Y”. In the present embodiment, “X/Y” encompasses the meaning of “X and Y”. In the present embodiment, “X/Y” encompasses the meaning of “X and/or Y”.

In FIG. 1, the base station apparatuses 100-1 and 100-2 transmit and receive uplink data (e.g. UL-SCH; uplink-shared channel), downlink data (e.g. DL-SCH; downlink-shared channel), uplink control information (e.g. UCI; uplink control information), downlink control information (e.g. DCI; downlink control information, etc.), and reference signals (such as UL-RS; uplink-reference signal and DL-RS; downlink-reference signal) through uplink signals r101, r103, and r105 and downlink signals r102, r104, and r106, respectively (these signals will be described in detail later).

In FIG. 1, the terminal apparatuses 200-1 and 200-2 include advanced reception functions (advanced signal detection function, NAICS; network assisted interference cancellation and suppression, and advanced SU-MIMO detection; single user-multiple input multiple output detection). Examples of these advanced reception functions include linear detection, maximum likelihood estimation, interference cancellers, and the like. Examples of linear detection include Enhanced LMMSE-IRC (linear minimum mean square error-interference rejection combining), WLMMSE-IRC (widely linear MMSE-IRC), and the like. Examples of maximum likelihood estimation include ML (maximum likelihood), R-ML (reduced complexity ML), iterative ML, iterative R-ML, and the like. Examples of interference cancellers include Turbo SIC (successive interference cancellation), PIC (parallel interference cancellation), L-CWIC (linear code word level SIC), ML-CWIC (ML code word level SIC), SLIC (symbol level IC), and the like. The linear detection, the maximum likelihood estimation, and the interference cancellers correspond to advanced reception functions in the NAICS. The maximum likelihood estimation and the interference cancellers correspond to advanced reception functions in the SU-MIMO detection.

It should be noted that the terminal apparatus 200-3 is a terminal apparatus having no advanced reception function. For example, as compared with a terminal apparatus having an advanced reception function in the NAICS, a terminal apparatus including linear reception such as MMSE or LMMSE-IRC detection corresponds to the terminal apparatus having no reception function. For example, as compared with a terminal apparatus having an advanced reception function in the SU-MIMO detection, a terminal apparatus including linear reception such as MMSE detection corresponds to the terminal apparatus having no reception function. It should be noted that the terminal apparatuses 200-1 and 200-2 may include linear reception such as MMSE detection.

In FIG. 1, the terminal apparatus 200-1 receives inter-cell interference from the downlink signal r104. The terminal apparatus 200-2 receives inter-cell interference from the downlink signal r102. The terminal apparatuses 200-1 and 200-2 cancel or suppress the inter-cell interference using the advanced reception functions.

In FIG. 1, the base station apparatuses 100-1 and 100-2 can spatially multiplex and transmit the downlink signals r102, r104, and r106. In this case, each of the terminal apparatuses receives inter-stream interference (inter-layer interference, inter-antenna interference). The terminal apparatuses 200-1 and 200-2 cancel or suppress the inter-stream interference using the advanced reception functions.

In FIG. 1, the base station apparatuses 100-1 and 100-2 transmit the downlink signals r101, r103, and r105 in accordance with configurations of predetermined radio frames. The terminal apparatuses 200-1 and 200-2 transmit the uplink signals r102, r104, and r106 in accordance with configurations of predetermined radio frames.

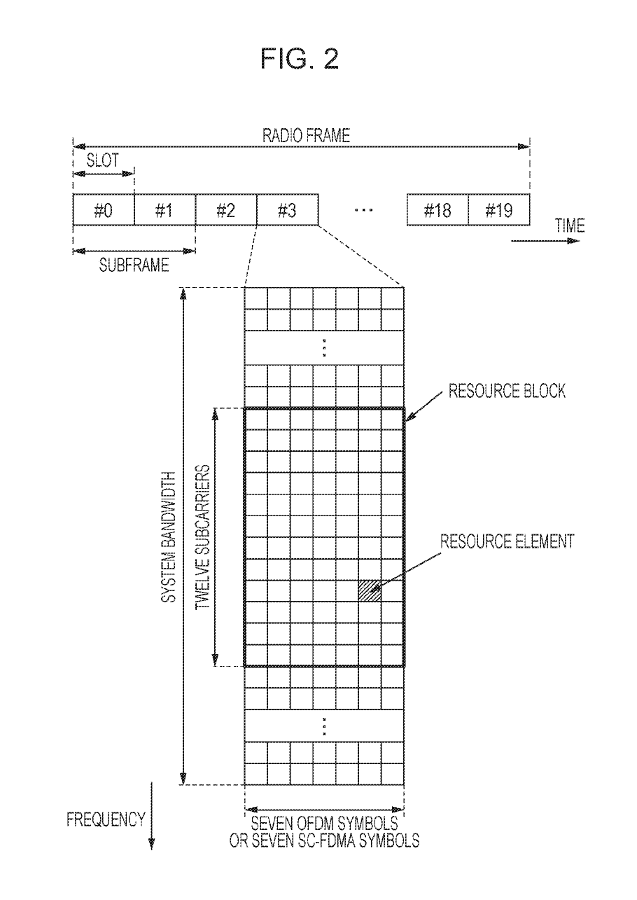

FIG. 2 is a diagram schematically showing a configuration of a radio frame according to the present embodiment. In FIG. 2, the horizontal axis represents a time axis. For example, in frequency division duplex (FDD), the base station apparatuses 100-1 and 100-2 and the terminal apparatuses 200-1, 200-2, and 200-3 each transmit the signals r101 to r106, respectively, in accordance with the radio frame of FIG. 2. For example, the length of each radio frame is Tf=307200·Ts=10 ms. Tf is referred to as “radio frame duration”. Ts is referred to as “basic time unit”.

A radio frame is constituted by two half frames, and the length of each half frame is 153600·Ts=5 ms. Each half frame is constituted by five subframes, and the length of each subframe is 30720·Ts=1 ms.

Each subframe is defined by two consecutive slots, and the length of each slot is a length of Tslot=15360·Ts 0.5 ms. The ith subframe in a radio frame is constituted by the (2×i)th slot and the (2×i+1)th slot. That is, ten subframes can be utilized in each interval of 10 ms. Note here that a subframe is also referred to as “TTI (transmission time interval)”. It should be noted that while FIG. 2 shows an example of application of frequency division duplex, it is also possible to apply time division duplex (TDD).

A physical signal or a physical channel that is transmitted in each slot is expressed by a resource grid. In the downlink, a resource grid is defined by a plurality of subcarriers and a plurality of OFDM symbols. In the uplink, a resource grid is defined by a plurality of subcarriers and a plurality of SC-FDMA symbols.

The number of subcarriers that constitute one slot depends on the system bandwidth (bandwidth of a cell). For example, the number of OFDM symbols or SC-FDMA symbols that constitute one slot is 7. Each element in a resource grid is referred to as “resource element”. A resource element is identified using the number of a subcarrier and the number of an OFDM symbol or an SC-FDMA symbol.

A resource block is used to express mapping of a physical channel (such as a PDSCH or a PUSCH) onto a resource element. As a resource block, a virtual resource block and a physical resource block are defined. A physical channel is first mapped onto a virtual resource block. Then, the virtual resource block is mapped onto a physical resource block.

For example, one physical resource block consists of seven consecutive OFDM symbols or SC-FDMA symbols in the time domain and twelve consecutive subcarriers in the frequency domain. One physical resource block is composed of (7×12) resource elements. One physical resource block corresponds to one slot in the time domain and corresponds to 180 kHz in the frequency domain. Physical resource blocks are numbered from 0 in the frequency domain.

In FIG. 1, downlink physical channels are used in wireless communication based on the downlink signals r101, r103, and r105 from the base station apparatuses 100-1 and 100-2 to the terminal apparatuses 200-1, 200-2, and 200-3. Downlink physical channels can be used to transmit information outputted from higher layers. Examples of downlink physical channels include a PBCH (physical broadcast channel), a PCFICH (physical control format indicator channel), a PHICH (physical hybrid automatic repeat request indicator channel), a PDCCH (physical downlink control channel), an EPDCCH (enhanced physical downlink control channel), a PDSCH (physical downlink shared channel), a PMCH (physical multicast channel), and the like.

The PBCH is used to broadcast a master information block (MIB; master information block, BCH; broadcast channel) that is commonly used by terminal apparatuses connected to a base station apparatuses in each cell. The MIB is system information. For example, the MIB contains basic information such as information (SFN; system frame number) indicating the number of a radio frame, the system bandwidth, and the number of transmitting antennas.

The PCFICH is used to transmit information specifying a region (OFDM symbols) that is used in the transmission of the PDCCH.

The PHICH is used to transmit a HARQ indicator (HARQ feedback, response information) indicating ACK (acknowledgement) or NACK (negative acknowledgement) to the uplink data received by the base station apparatuses 100-1 and 100-2.

The PDCCH and the EPDCCH are used to transmit downlink control information (DCI). A plurality of DCI formats are defined for the transmission of the downlink control information. A field for the downlink control information is defined in a DCI format and mapped onto an information bit. The downlink control information may be referred to as “DCI format”.

A base station apparatus explicitly or implicitly broadcasts information pertaining to the application of an advanced reception function. For example, the DCI format may contain a field for a terminal apparatus to transmit information pertaining to the application of the advanced reception function. Further, the DCI format allows the terminal apparatus to report the information pertaining to the application of the advanced reception function by using a particular DCI format among a plurality of DCI formats.

For example, a plurality of DCI formats such as a DCI format 1A, a DCI formant 1B, a DCI format 1D, a DCI format 1, a DCI format 2A, a DCI format 2B, a DCI format 2C, and a DCI format 2D are defined as DCI formats for the downlink. The DCI formats are defined by the types (fields) of control information that are needed as DCI for the downlink, the information amounts (bit numbers) of necessary control information, and the like.

For example, a DCI format for the downlink contains information pertaining to the scheduling of the PDSCH. The DCI format for the downlink is also referred to as “downlink grant (or downlink assignment)”. For example, the DCI format for the downlink contains downlink control information such as information pertaining to resource block assignment, information pertaining to an MCS (modulation and coding scheme), information pertaining to a spatial multiplexing order (number of layers), information pertaining to a TPC command to the PUCCH, and a downlink assignment index (DAI).

For example, in a case where a terminal apparatus has received information pertaining to the application of the advanced reception function through downlink control information (DCI) for the downlink, the terminal apparatus uses the advanced reception function to perform signal detection of the PDSCH scheduled by the DCI.

In another example, in a case where a terminal apparatus has received information pertaining to the application of the advanced reception function through downlink control information, the terminal apparatus uses the advanced reception function to perform signal detection of the scheduled PDSCH until the receiving apparatus receives information pertaining to the application of the advanced reception function through the subsequent downlink control information. Information pertaining to the application of the advanced reception by the terminal apparatus may use “0” or “1” to indicate whether the advanced reception function is appropriate. Further, whether the advanced reception function is appropriate may be indicated by the presence or absence in downlink control information of information pertaining to the application of the advanced reception.

Further, the downlink control information may contain information pertaining to an interfering signal. The information pertaining to an interfering signal is information that is needed to demodulate the interfering signal, such as a modulation scheme, information pertaining to an MCS (modulation and coding scheme), and information pertaining to a spatial multiplexing order (number of layers).

Further, the DCI formats include a DCI format for the uplink. For example, a DCI format 0, which is used for the scheduling of one PUSCH (transmission of one uplink transport block) in one cell, is defined.

For example, the DCI format for the uplink contains information pertaining to the scheduling of the PUSCH. For example, the DCI format for the uplink contains downlink control information such as information pertaining to resource block assignment, information pertaining to an MCS, and information pertaining to a TPC command to the PUSCH. Note here that the DCI format for the uplink is also referred to as “uplink grant (or uplink assignment)”.

Further, the DCI format for the uplink can be used to make a request (CSI request) for channel state information (CSI; also referred to as “reception quality information”) of the downlink. The channel state information corresponds to a rank indicator RI that indicates a preferred spatial multiplexing order, a precoding matrix indicator PMI that indicates a preferred precoder, a channel quality indicator CQI that indicates a preferred transmission rate, and the like (which will be described in detail later).

Further, the DCI format for the uplink can be used for a configuration indicating an uplink resource on which to map a channel state information report (CSI feedback report) that the terminal apparatus feeds back to the base station apparatus. For example, the channel state information report can be used for a configuration indicating an uplink resource for periodically reporting channel state information (periodic CSI). The channel state information report can be used for a mode configuration (CSI report mode) in which channel state information is periodically reported.

For example, the channel state information report can be used for a configuration indicating an uplink resource for reporting aperiodic channel state information (aperiodic CSI). The channel state information report can be used for a mode configuration (CSI report mode) in which channel state information is aperiodically reported. The base station apparatuses 100-1 and 100-2 can configure either the periodic channel state information report or the aperiodic channel state information report. Further, the base station apparatuses 100-1 and 100-2 can also configure both the periodic channel state information report and the aperiodic channel state information report.

Further, the DCI format for the uplink can be used for a configuration indicating a type of channel state information report that the terminal apparatus feeds back to the base station apparatus. Examples of types of channel state information report include wideband CSI (e.g. wideband CQI), narrowband CSI (e.g. subband CQI), and the like.

Further, the DCI format for the uplink can be used for a mode configuration including the periodic channel state information report or the aperiodic channel state information report and a type of the channel state information report. Examples include a mode in which an aperiodic channel state information report and wideband CSI are reported, a mode in which an aperiodic channel state information report and narrowband CSI are reported, a mode in which an aperiodic channel state information report, wideband CSI, and narrowband CSI are reported, a mode in which a periodic channel state information report and wideband CSI are reported, a mode in which a periodic channel state information report and narrowband CSI are reported, and a mode in which a periodic channel state information report, wideband CSI, and narrowband CSI are reported.

In a case where resources for the PDSCH have been scheduled using a downlink assignment, the terminal apparatuses 200-1, 200-2, and 200-3 receive downlink data through the scheduled PDSCH. Further, in a case where resources for the PUSCH have been scheduled using an uplink grant, the terminal apparatuses 200-1, 200-2, and 200-3 transmit uplink data and/or uplink control information through the scheduled PUSCH.

The terminal apparatuses 200-1, 200-2, and 200-3 monitor a set of PDCCH candidates and/or EPDCCH candidates. In the following description, the PDCCH may indicate the PDCCH and/or the EPDDCH. The PDCCH candidates are candidates to which the PDCCH may be mapped and transmitted by the base station apparatuses 100-1 and 100-2. Further, the term “monitor” may encompass such a meaning that according to all DCI formats that are monitored, the terminal apparatuses 200-1, 200-2, and 200-3 attempt to decode each of the PDCCHs in the set of PDCCH candidates.

The set of PDCCH candidates that the terminal apparatuses 200-1, 200-2, and 200-3 monitor is also referred to as “search space”. The search space includes a common search space (CSS) and a UE-specific search spacer (USS). The CSS is a region, in a cell that a base station apparatus constitutes, where a plurality of terminal apparatuses connected to the base station apparatus monitor PDCCHs and/or EPDCCHs in common. The terminal apparatuses 200-1, 200-2, and 200-3 monitor PDCCHs in the CSS and/or the USS and detect PDCCHs addressed thereto.

In the transmission of downlink control information (PDCCH transmission), RNTI that the base station apparatuses 100-1 and 100-2 assigned to the terminal apparatuses 200-1, 200-2, and 200-3 is utilized. Specifically, CRC (cyclic redundancy check) parity bits are appended to the downlink control information, and after having been appended, the CRC parity bits are scrambled by the RNTI. Note here that the CRC parity bits that are appended to the downlink control information may be obtained from a payload of the downlink control information.

The terminal apparatuses 200-1, 200-2, and 200-3 attempt to decode the downlink control information to which the CRC parity bits scrambled by the RNTI have been appended, and detects, as downlink control information addressed thereto, downlink control information having succeeded in CRC (also referred to as “blind decoding”). That is, the terminal apparatuses 200-1, 200-2, and 200-3 detect a PDCCH with the CRC scrambled by the RNTI. Further, the terminal apparatus 1 detects a PDCCH with a DCI formed to which the CRC parity bits scrambled by the RNTI have been appended.

The PDSCH is used to transmit downlink data. Hereinafter, the transmission of downlink data through the PDSCH is also referred to as “PDSCH transmission”. Further, the reception of downlink data through the PDSCH is also referred to as “PDSCH reception”.

The PDSCH is used to transmit a system information block type 1 message. Further, the system information block type 1 message is cell-specific information. Further, the system information block type 1 message is an RRC message (common RRC message, RRC message that is common to terminals).

The PDSCH is used to transmit a system information message. The system information message may contain a system information message block X other than the system information block type 1 message. Further, the system information message is cell-specific information. Further, the system information message is an RRC message.

The PDSCH is used to transmit an RRC message. RRC messages that are transmitted from the base station apparatuses 100-1 and 100-2 may be common to the plurality of terminal apparatuses in the cell. Further, an RRC message that is transmitted from the base station apparatus 100-1 may be a dedicated message (also referred to as “dedicated signaling”) to the terminal apparatus 200-1. Similarly, an RRC message that is transmitted from the base station apparatus 100-2 may be a dedicated message to the terminal apparatus 200-2. That is, US-specific information is transmitted using a dedicated message to a terminal apparatus. Further, the PDSCH is used to transmit an MAC CE. Note here that an RRC message and/or an MAC CE is/are also referred to as “higher layer signaling”.

The PDSCH can be used to for a terminal apparatus to report information pertaining to the application of the advanced reception function. For example, an RRC message may contain information pertaining to whether a terminal apparatus applies the advanced reception function.

For example, in a case where a terminal apparatus has received information pertaining to the application of the advanced reception function through the PDSCH, the terminal apparatus uses the advanced reception function to perform signal detection of the scheduled PDSCH until the receiving apparatus receives information pertaining to the application of the advanced reception function through the subsequent PDSCH. Information pertaining to the application of the advanced reception by the terminal apparatus may use “0” or “1” to indicate whether the advanced reception function is appropriate. Further, whether the advanced reception function is appropriate may be indicated by the presence or absence in the PDSCH of information pertaining to the application of the advanced reception by the terminal apparatus.

The PDSCH can be used to make a request for the channel state information of the downlink. The channel state information corresponds to a rank indicator RI that indicates a preferred spatial multiplexing order, a precoding matrix indicator PMI that indicates a preferred precoder, a channel quality indicator CQI that indicates a preferred transmission rate, and the like.

The PDSCH can be used to transmit an uplink resource on which to map a channel state information report (CSI feedback report) that the terminal apparatus feeds back to the base station apparatus. For example, the channel state information report can be used for a configuration indicating an uplink resource for periodically reporting channel state information (periodic CSI). The channel state information report can be used for a mode configuration (CSI report mode) in which channel state information is periodically reported.

For example, the channel state information report can be used for a configuration indicating an uplink resource for reporting aperiodic channel state information (aperiodic CSI). The channel state information report can be used for a mode configuration (CSI report mode) in which channel state information is aperiodically reported. The base station apparatuses 100-1 and 100-2 can configure either the periodic channel state information report or the aperiodic channel state information report. Further, the base station apparatuses 100-1 and 100-2 can also configure both the periodic channel state information report and the aperiodic channel state information report.

Further, the PDSCH can be used to transmit a type of channel state information report that the terminal apparatus feeds back to the base station apparatus. Examples of types of channel state information report include wideband CSI (e.g. wideband CQI), narrowband CSI (e.g. subband CQI), and the like.

Further, the PDSCH can transmit a mode configuration including a configuration of the periodic channel state information report or the aperiodic channel state information report configuration and a type configuration of the channel state information report. Examples of the mode configuration include a mode in which a periodic channel state information report and wideband CSI are reported, a mode in which a periodic channel state information report and narrowband CSI are reported, and the like.

The PMCH is used to transmit multicast data (MCH; multicast channel).

Downlink physical signals are used in wireless communication based on the downlink signals r101, r103, and r105) from the base station apparatuses 100-1 and 100-2 to the terminal apparatuses 200-1, 200-2, and 200-3. Downlink physical signals are not used to transmit information outputted from higher layers, but are used by the physical layer. Downlink physical signals include synchronization signals (SSs), downlink reference signals (DL-RSs), and the like.

The synchronization signals are used for the terminal apparatuses 200-1, 200-2, and 200-3 to synchronize the frequency and time domains of the downlink with each other.

The downlink reference signals are used for the terminal apparatuses 200-1, 200-2, and 200-3 to make channel corrections to downlink physical channels. Further, the downlink reference signals may be used for the terminal apparatuses 200-1, 200-2, and 200-3 to calculate the channel state information of the downlink. Examples of types of downlink reference signal include a CRS (cell-specific reference signal), a URS (UE-specific reference signal) associated with the PDSCH, a DMRS (demodulation reference signal) associated with the EPDCCH, an NZP CSI-RS (non-zero power channel state information-reference signal), a ZP CSI-RS (zero power channel state information-reference signal), an MBSFN RS (multimedia broadcast and multicast service over single frequency network reference signal), a PRS (positioning reference signal), and the like.

The CRS is transmitted over the full bandwidth of subframes. The CRS is used to demodulate the PBCH, the PDCCH, the PHICH, the PCFICH, the PDSCH, and the like. The CRS may be used for the terminal apparatuses 200-1, 200-2, and 200-3 to calculate the channel state information of the downlink. The PBCH, the PDCCH, the PHICH, and the PCFICH are transmitted on an antenna port that is used in the transmission of the CRS.

The URS associated with the PDSCH is transmitted over a subframe and a band that are used in the transmission of the PDSCH with which the URS is associated. The URS is used to demodulate the PDSCH with which the URS is associated.

The PDSCH is transmitted on the antenna port that is used in the transmission of the CRS or the URS. The DCI format 1A is used in the scheduling of the PDSCH that is transmitted on the antenna port that is used in the transmission of the CRS. For example, the CRS is transmitted on one or several of antenna ports i (i=0, 1, 2, 3).

The DMRS associated with the EPDCCH is transmitted over a subframe and a band that are used in the transmission of the EPDCCH with which the DMRS is associated. The DMRS is used to demodulate the EPDCCH with which the DMRS is associated. The EPDCCH is transmitted on an antenna port that is used in the transmission of the DMRS.

The NZP CSI-RS is transmitted in a configured subframe. Resources across which the NZP CSI-RS is transmitted is configured by the base station apparatus. The NZP CSI-RS is used for the terminal apparatus 1 to calculate the channel state information of the downlink. The terminal apparatus 1 performs signal measurements (channel measurements) with reference to the NZP CSI-RS.

Resources for the ZP CSI-RS are configured by the base station apparatuses 100-1 and 100-2. The base station apparatus 3 transmits the ZP CSI-RS with zero output. That is, the base station apparatuses 100-1 and 100-2 do not transmit the ZP CSI-RS. The base station apparatuses 100-1 and 100-2 do not transmit the PDSCH and the EPDCCH across the configured resources for the ZP CSI-RS. For example, the terminal apparatuses 200-1, 200-2, and 200-3 can measure interference in resources to which the NZP CSI-RS corresponds in a cell.

The MBSFN RS is transmitted over the full bandwidth of subframes that are used in the transmission of the PMCH. The MBSFN RS is used to demodulate the PMCH. The PMCH is transmitted on an antenna port that is used in the transmission of the MBSFN RS.

The PRS is used for a terminal apparatus to measure the geographical location of the terminal apparatus.

Uplink physical channels are used in wireless communication based on the uplink signals r101, r103, and r105 from the terminal apparatuses 200-1, 200-2, and 200-3 to the base station apparatuses 100-1 and 100-2. The uplink physical channels can be used to transmit information outputted from higher layers. The uplink physical channels include a PUCCH (physical uplink control channel), a PUSCH (physical uplink shared channel), a PRACH (physical random access channel), and the like.

The PUCCH is used to transmit uplink control information (UCI). The uplink control information contains channel state information (CSI) of the downlink and a scheduling request (SR) indicating a request for PUSCH resources. The channel state information corresponds to a rank indicator RI that indicates a preferred spatial multiplexing order, a precoding matrix indicator PMI that indicates a preferred precoder, a channel quality indicator CQI that indicates a preferred transmission rate, and the like.

The channel quality indicator CQI (hereinafter, CQI value) may be a modulation scheme (such as QPSK, 16QAM, 64QAM, 256QAM) or a code rate that is suitable in a predetermined band (which will be described in detail later). The CQI value may be an index (CQI index) determined by the modification scheme or the code rate. The CQI value may be one determined in advance by the system.

It should be noted that the rank indicator and the precoding quality index may be ones determined in advance by the system. The rank indicator and the precoding matrix indicator may be indices determined by the spatial multiplexing order or precoding matrix information. The values of the rank indicator, the precoding matrix indicator, and the channel quality indicator CQI are collectively referred to as “CSI values”.

Further, the uplink control information contains ACK (acknowledgement)/NACK (negative-acknowledgement) to downlink data (downlink transport block, DL-SCH; downlink-shared channel). Note here that the ACK/NACK is also referred to as “HARQ-ACK”, “HARQ feedback”, or “response information”. Further, the PUCCH may be used to for a terminal apparatus to transmit information pertaining to the advanced reception function. Further, the PUCCH may be used for a terminal apparatus to transmit information (UE capability) indicating that the terminal apparatus includes the advanced reception function.

The PUSCH is used to transmit uplink data (uplink transport block, uplink-shared channel: UL-SCH). That is the transmission of the uplink data over the UL-SCH is performed via the PUSCH. That is, the UL-SCH, which is a transport channel, is mapped onto the PUSCH, which is a physical channel. Further, the PUSCH man be used to transmit HARQ-ACK and/or channel state information together with the uplink data. Further, the PUSCH may be used to transmit only channel state information or only HARQ-ACK and channel state information.

Further, the PUSCH is used to transmit an RRC message. The RRC message is information/signaling that is processed by a radio resource control (RRC) layer. The RRC message may be used for a terminal apparatus to transmit information pertaining to the advanced reception function. The RRC message may be used for a terminal apparatus to transmit information indicating that the terminal apparatus includes the advanced reception function. Further, the PUSCH is used to transmit an MAC CE (control element). Note here that the MAC CE is information/signaling that is processed (transmitted) by a medium access control (MAC) layer. The MAC CE may be used for a terminal apparatus to transmit information pertaining to the advanced reception function. The MAC CE may be used for a terminal apparatus to transmit information indicating that the terminal apparatus includes the advanced reception function.

The PRACH is used to transmit a random access preamble. The PRACH is used to indicate an initial connection establishment procedure, a handover procedure, a connection re-establishment procedure, synchronization with uplink transmission (timing adjustment), and a request for PUSCH resources.

Uplink physical signals are used in wireless communication based on the uplink signals r101, r103, and r105 from the terminal apparatuses 200-1, 200-2, and 200-3 to the base station apparatuses 100-1 and 100-2. The uplink physical signals are not used to transmit information outputted from higher layers, but are used by the physical layer. The uplink physical signals include uplink reference signals (UL RSs). The uplink reference signals include a DMRS (demodulation reference signal) and an SRS (sounding reference signal).

The DMRS is associated with the transmission of the PUSCH or the PUCCH. The DMRS is time-multiplexed with the PUSCH or the PUCCH. For example, the base station apparatuses 100-1 and 100-2 use the DMRS to make a channel correction to the PUSCH or the PUCCH.

The SRS is not associated with the transmission of the PUSCH or the PUCCH. The base station apparatuses 200-1, 200-2, and 200-3 use the SRS to measure the channel state of the uplink. The terminal apparatuses 200-1, 200-2, and 200-3 transmit a first SRS in first resources configured by higher layers. Furthermore, in a case where the terminal apparatuses 200-1, 200-2, and 200-3 have received, through the PDCCH, information indicating a request for the transmission of the SRS, the terminal apparatuses 200-1, 200-2, and 200-3 only once transmit a second SRS in second resources configured by higher layers. Note here that the first SRS is also referred to as “periodic SRS” or “type 0 triggered SRS”. Further, the second SRS is also referred to as “aperiodic SRS” or “type 1 triggered SRS”.

It should be noted that the downlink physical channels and the downlink physical signals are also collectively referred to as “downlink signals”. Further, the uplink physical channels and the uplink physical signals are also collectively referred to as “uplink signals”. Further, the downlink physical channels and the uplink physical channels are also collectively referred to as “physical channels”. Further, the downlink physical signals and the uplink physical signals are also collectively referred to as “physical signals”.

Further, the BCH, the MCH, the UL-SCH, and the DL-SCH are transport channels. A channel that is used by the medium access control (MAC) layer is referred to as “transport channel”. A unit of the transport channel that is used by the MAC layer is also referred to as “transport block (TB)” or “MAC PDU (protocol data unit)”. In the MAC layer, the control of HARQ (hybrid automatic repeat request) is performed for each transport block. The transport block is a unit of data that the MAC layer delivers to a physical layer. In the physical layer, the transport block is mapped to a code word, and a coding process is performed for each code word.

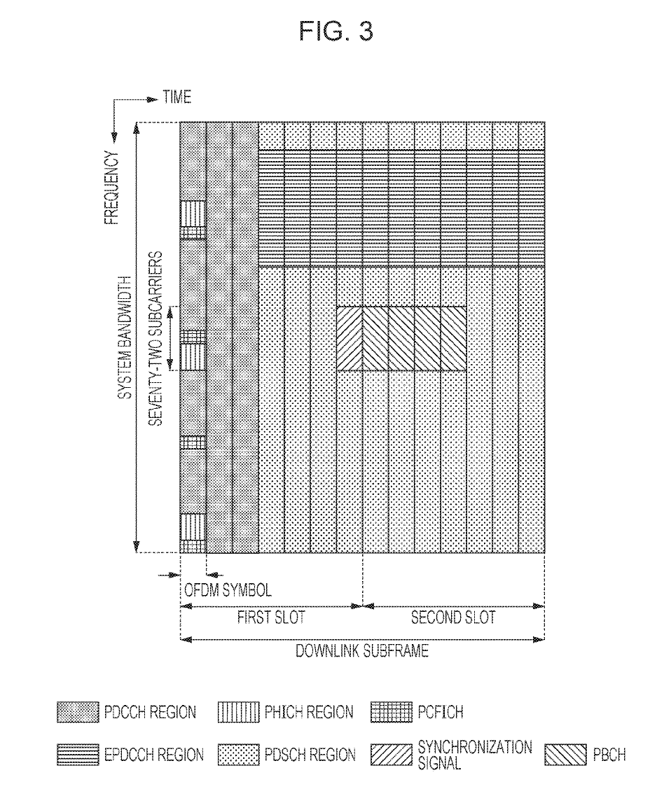

FIG. 3 is a diagram showing an example of the allocation of physical channels and physical signals in a downlink subframe according to the present embodiment. In FIG. 3, the horizontal axis represent a time axis, and the vertical axis represents a frequency axis. The base station apparatuses 100-1 and 100-2 may transmit downlink physical channels (PBCHs, PCFICHs, PHICHs, PDCCHs, EPDCCHs, and PDSCHs) and downlink physical signals (synchronization signals and downlink reference signals) in the downlink subframe. Note here that, for simplification of explanation, FIG. 3 does not illustrate downlink reference signals.

In a PDCCH region, a plurality of PDCCHs may be frequency-multiplexed and time-multiplexed. In an EPDCCH region, a plurality of EPDCCHs may be frequency-multiplexed, time-multiplexed, and spatially multiplexed. In a PDSCH region, a plurality of PDSCHs may be frequency-multiplexed and spatially multiplexed. The PDCCHs and the PDSCHs or the EPDCCHs may be time-multiplexed. The PDSCHs and the EPDCCHs may be frequency-multiplexed.

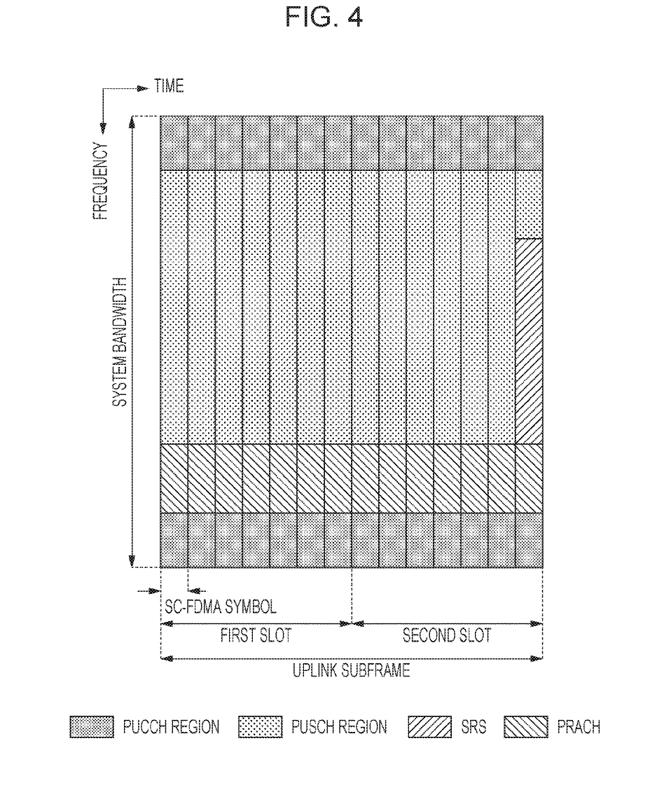

FIG. 4 is a diagram showing an example of the allocation of physical channels and physical signals in an uplink subframe according to the present embodiment. In FIG. 4, the horizontal axis represent a time axis, and the vertical axis represents a frequency axis. The terminal apparatuses 200-1, 200-2, and 200-3 may transmit uplink physical channels (PUCCHs, PUSCHs, and PRACHs) and uplink physical signals (DMRS and SRS) in the uplink subframe.

In a PUCCH region, a plurality of PUCCHs may be frequency-, time-, and code-multiplexed. In a PUSCH region, a plurality of PUSCHs may be frequency-multiplexed and spatially multiplexed. The PUCCHs and the PUSCHs may be frequency-multiplexed. A PRACH may be allocated in a single subframe or across two subframes. Further, a plurality of PRACHs may be code-multiplexed.

The SRS may be transmitted using the last SC-FDMA symbol in the uplink subframe. In a single uplink subframe of a single cell, the terminal apparatuses 200-1, 200-2, and 200-3 can perform PUSCH and/or PUCCH transmissions using SC-FDMA symbols excluding the last SC-FDMA symbol in the uplink subframe, and can perform SRS transmissions using the last SC-FDMA symbol in the uplink subframe.

That is, in a single uplink subframe of a single cell, the terminal apparatuses 200-1, 200-2, and 200-3 can perform both SRS transmissions and PUSCH and/or PUCCH transmissions. The DMRS may be time-multiplexed with the PUCCHs or the PUSCHs. For simplification of explanation, FIG. 4 does not illustrate the DMRS.

Next, the types of channel state information report of the downlink are described. The types of channel state information report of the downlink are classified into wideband CSI (e.g. wideband CSI) and narrowband CSI (e.g. subband CSI). Wideband CSI is calculated as one piece of channel state information with respect to the system bandwidth of a cell. For example, one piece of channel state information is calculated with respect to the system bandwidth in FIG. 3.

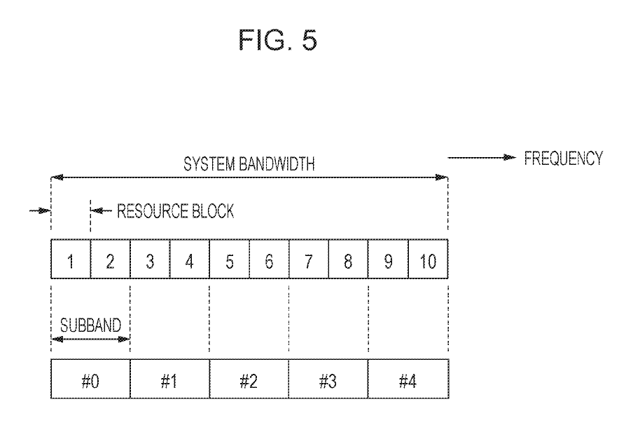

Narrowband CSI is calculated by partitioning the system bandwidth into predetermined units and as one piece of channel state information with respect to each of the partitions. FIG. 5 is a diagram showing an example of calculation of narrowband CSI according to the present embodiment. In the communication system according to the present embodiment, the system bandwidth is constituted by a plurality of resource blocks. As described with reference to FIG. 2, each of the resource blocks is an aggregation constituted by a plurality of resource elements. In the example shown in FIG. 5, the system bandwidth is constituted by ten resource blocks.

The system bandwidth is partitioned into groups (subbands in FIG. 5; hereinafter referred to as “subbands”) each constituted by a plurality of resource blocks. The number of these subbands can be calculated on the basis of a configuration of the size of each of these subbands (i.e. the number of resource blocks that constitute the subband). The subband size can be configured on the basis of the system bandwidth. In the example shown in FIG. 5, the subband size is 2. It should be noted that not all of the subbands need to be the same in subband size and there may be a subband of a different size.

The subband size can be configured in advance by the system. The subbands each constituted by a plurality of resource blocks can be given indices. In the example shown in FIG. 5, indices are given in ascending order to subbands assigned to low frequencies.

In the case of calculation of narrowband CSI in FIG. 5, a CSI value is calculated for each of the subbands each constituted by a plurality of resource blocks. For example, the CSI value may be a CSI value that a terminal apparatus can receive with predetermined reception quality. The predetermined reception quality may be a predetermined error rate.

The subband size (number of resource blocks) can be configured differently depending on the presence or absence of application of the advanced reception function. For example, in the same system bandwidth, a size constituting the subband in a case where the advanced reception function is applied may be smaller than a size in a case where the advanced reception function is applied. That is, the number of subbands in a case where the advanced reception function is applied may be larger in the number of subbands in the same system bandwidth than the number of subbands in a case where the advanced reception function is applied.

In FIG. 5, the terminal apparatus can report one CSI value to a base station apparatus for all of the subbands that constitute the system bandwidth. Further, the terminal apparatus can select a preferred predetermined number of subbands from among the subbands that constitute the system bandwidth and report one CSI value for the subbands thus selected to the base station apparatus. The number of subbands to be selected can be configured on the basis of the system bandwidth. The preferred number of subbands to be reported can be configured in advance by the system.

In the case of a mode configuration in which a preferred predetermined number of subbands are selected from among the subbands that constitute the system bandwidth and a CSI value for the subbands thus selected is reported to the base station apparatus, the indices of the subbands thus selected can be reported. The indices of the subbands can be reported together with the CSI value. In FIG. 5, a report mode configuration of the narrowband CSI can be transmitted to the terminal apparatus by the base station apparatus. For example, it can be transmitted using the PDCCH and the PDSCH.

In FIG. 5, it is possible to report the CSI values of both narrowband CSI and wideband CSI. In this case, the CSI value of the narrowband CSI can be indicated by the delta of the CSI value of the wideband CSI.

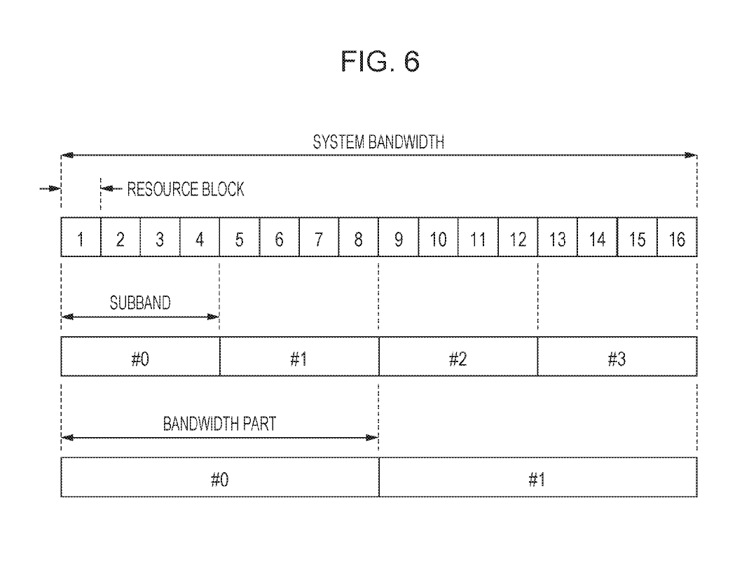

FIG. 6 is a diagram showing another example of calculation of narrowband CSI according to the present embodiment. In the communication system according to the present embodiment, the system bandwidth is constituted by a plurality of resource blocks. In the example shown in FIG. 6, the system bandwidth is constituted by sixteen resource blocks.

The system bandwidth is partitioned into groups (subbands in FIG. 6; hereinafter referred to as “subbands”) each constituted by a plurality of resource blocks. The number of these subbands can be calculated on the basis of a configuration of the size of each of these subbands (i.e. the number of resource blocks that constitute the subband). The subband size can be configured on the basis of the system bandwidth. The subbands each constituted by a plurality of resource blocks can be given indices. In the example shown in FIG. 5, indices are given in ascending order to subbands assigned to low frequencies.

The system bandwidth is partitioned into groups (bandwidth parts in FIG. 6; hereinafter referred to as “bandwidth parts”) each constituted by a plurality of the subbands. The number of these bandwidth parts can be configured on the basis of the system bandwidth. The bandwidth parts can be given indices. In the example shown in FIG. 6, indices are given in ascending order to bandwidth parts assigned to low frequencies.

The subband size and the number of bandwidth parts can be configured in advance by the system. In the example shown in FIG. 6, the subband size is 4 and the number of bandwidth parts is 2.

In the case of calculation of narrowband CSI in FIG. 6, a CSI value is calculated for each of the subbands each constituted by a plurality of resource blocks. For example, the CSI value may be a CSI value that a terminal apparatus can receive with predetermined reception quality. The predetermined reception quality may be a predetermined error rate.

The subband size (number of resource blocks) can be configured differently depending on the presence or absence of application of the advanced reception function. For example, in the same system bandwidth, a size constituting the subband in a case where the advanced reception function is applied may be smaller than a size in a case where the advanced reception function is applied. That is, the number of subbands in a case where the advanced reception function is applied may be larger in the number of subbands in the same system bandwidth than the number of subbands in a case where the advanced reception function is applied. The number of bandwidth parts can be configured differently depending on the presence or absence of application of the advanced reception function. For example, in the same system bandwidth, the number of bandwidth parts in a case where the advanced reception function is applied may be larger than the number of bandwidth parts in a case where the advanced reception function is applied. This makes it possible to finely configure a CSI value according to a channel state, thus making it possible to improve transmitting efficiency through the interference cancellation effect of the advanced reception function.

In FIG. 6, in each bandwidth parts, the terminal apparatus can select a preferred predetermined number of subbands from among the plurality of subbands that constitute the bandwidth part, and can report one CSI value for the subbands thus selected to the base station apparatus. The preferred predetermined number of subbands can be configured in advance by the system. For example, in a case where the preferred predetermined number of subbands is 1, a subband index with a more preferred CSI value is selected from among subband indices #0 and #1 of bandwidth part index #0 in FIG. 6, and the CSI value is reported to the base station apparatus.

In the case of a mode configuration in which, in each bandwidth part, a preferred predetermined number of subbands are selected from among the subbands that constitute the system bandwidth and one CSI value for the subbands thus selected is reported to the base station apparatus, the indices of the subbands thus selected can be reported. The indices of the subbands can be signaled together with the CSI value. In FIG. 6, a report mode configuration of the narrowband CSI can be transmitted to the terminal apparatus by the base station apparatus. For example, it can be notified using the PDCCH and the PDSCH.

In FIG. 6, the terminal apparatus can report the CSI value and/or subband indices of each bandwidth part to the base station apparatus in sequence. In FIG. 6, it is possible to report the CSI values of both narrowband CSI and wideband CSI. In this case, the CSI value of the narrowband CSI can be indicated by the delta of the CSI value of the wideband CSI.

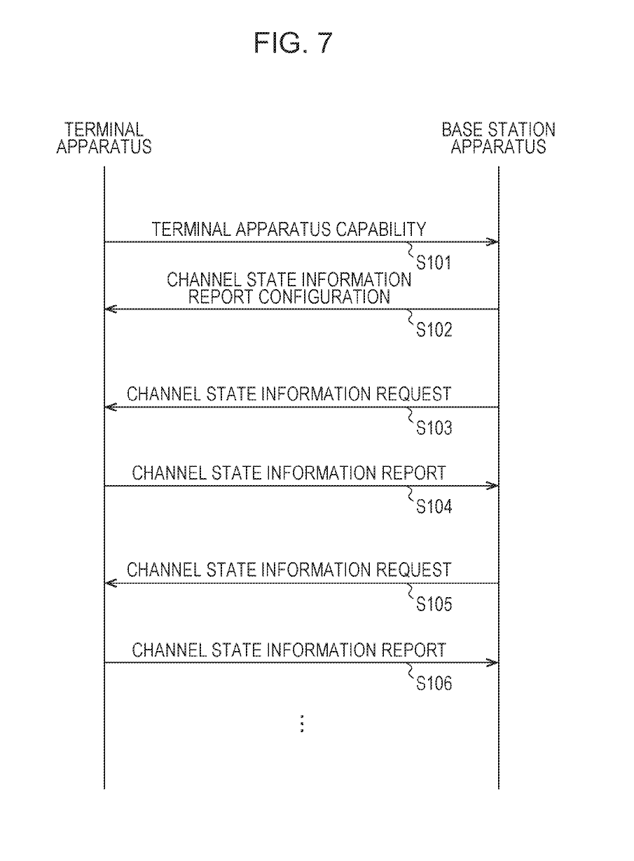

FIG. 7 is a diagram showing a sequence in the case of aperiodic reporting of channel state information. A terminal apparatus in FIG. 7 reports the capability (UE capability) of the terminal apparatus to a base station apparatus to which the terminal apparatus is connected (S101). The terminal apparatus notifies the base station apparatus through information on the capability that the terminal apparatus includes an advanced reception function. The base station apparatus transmits downlink reference signals (such as a CRS). The resource assignment of the reference signals is shown in FIG. 3. The terminal apparatus estimates a channel state with reference to the reference signals (not illustrated).

In FIG. 7, the base station apparatus transmits a channel state information report configuration to the terminal apparatus (S102). For example, the base station apparatus transmits the channel state information report configuration as an RRC message. Through the channel state information report configuration, the base station apparatus transmits, to the terminal apparatus, a mode configuration in which wideband CSI is fed back and a mode configuration in which narrowband CSI is fed back. The base station apparatus can transmit a mode configuration in a narrowband CSI report (such as a mode configuration in which CSI values for all subbands are transmitted or a mode configuration in which CSI for a preferred number of subbands is transmitted).

The channel state information report configuration may be a mode configuration including a configuration of the periodic channel state information report or the aperiodic channel state information report configuration and a configuration of a type of the channel state information report. Examples of the mode configurations include a mode in which an aperiodic channel state information report and wideband CSI are reported, a mode in which an aperiodic channel state information report and narrowband CSI are reported, an aperiodic channel state information report, wideband CSI, and narrowband CSI, a mode in which a periodic channel state information report and wideband CSI are reported, a mode in which a periodic channel state information report and narrowband CSI are reported, a mode in which a periodic channel state information report, wideband CSI, and narrowband CSI are reported, and the like.

The channel state information report configuration can assign the configuration of the periodic channel state information report or the aperiodic channel state information report configuration and the configuration of the type of the channel state information report to different physical channels. For example, the periodic channel state information report or the aperiodic channel state information report can be transmitted through the PDSCH. The configuration of the type of the channel state information report can be transmitted through the PDCCH.

By transmitting the channel state information report configuration, the base station apparatus transmits, to the terminal apparatus, a mode configuration of an aperiodic channel state information report and/or a mode configuration of a periodic channel state information report. The following describes the case of a mode configuration of an aperiodic channel state information report.

The base station apparatus transmits a channel state information request (CSI request) to the terminal apparatus (S103). For example, the channel state information request (CSI request) can be transmitted through a PDCCH. The channel state information request (CSI request) may contain a mode configuration of wideband CSI or a mode configuration of narrowband CSI. After having received the channel state information request, the terminal apparatus feeds back a channel state report to the base station apparatus through a predetermined subframe (S104). For example, the terminal apparatus feeds back the channel state report in accordance with the resource assignment of the PUSCH contained in the PDCCH thus transmitted. Further, the terminal apparatus can feed back the channel state information report in accordance with the resource assignment determined with reference to the timing of reception of the PDCCH. As the channel state information report, the terminal apparatus feeds back a CSI value based on the channel state information report configuration.

In FIG. 7, every time the terminal apparatus receives a request for downlink channel state information from the base station apparatus, the terminal apparatus reports the channel state information to the base station apparatus (S105, S106).

For example, in a case where the channel state information report configuration is a mode configuration of an aperiodic channel state information report (S102) and the channel state information request is a wideband CSI report configuration (S103), the terminal apparatus reports the CSI value of wideband CSI to the base station apparatus as the channel state information report (S104).

In a case where the channel state information report configuration is a mode configuration of an aperiodic channel state information report (S102) and the channel state information report configuration is a narrowband CSI report configuration (S103), the terminal apparatus reports the CSI value of narrowband CSI to the base station apparatus as the channel state information report (S104).

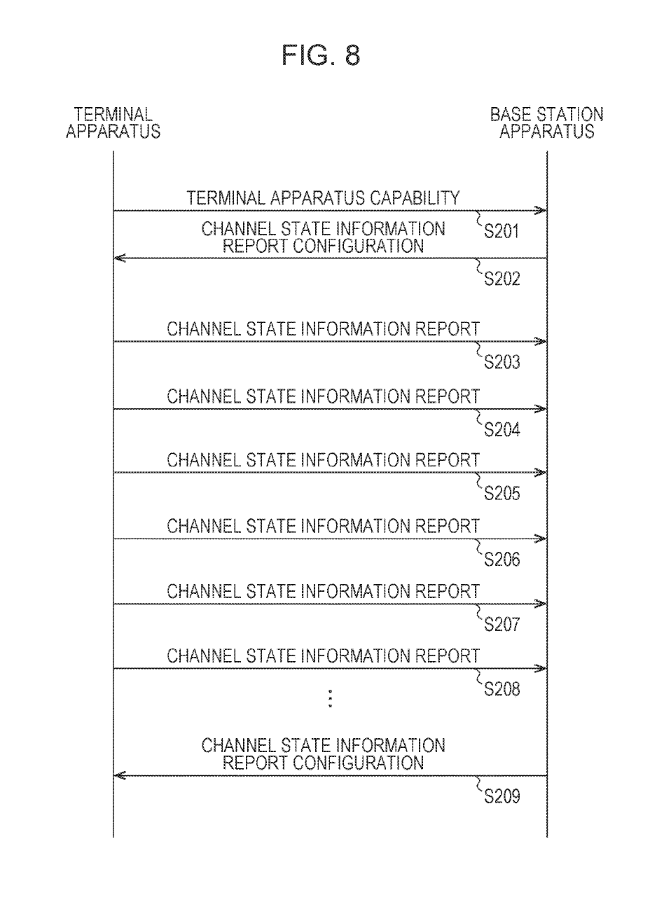

FIG. 8 is a diagram showing a sequence in the case of periodic reporting of channel state information. A terminal apparatus in FIG. 8 reports the capability WE capability) of the terminal apparatus to a base station apparatus to which the terminal apparatus is connected (S201). The base station apparatus transmits downlink reference signals (such as a CRS). The terminal apparatus estimates a channel state with reference to the reference signals (not illustrated).

In FIG. 8, the base station apparatus transmits a channel state information report configuration to the terminal apparatus (S202). For example, the base station apparatus transmits the channel state information report configuration as an RRC message. Through the channel state information report configuration, the base station apparatus transmits, to the terminal apparatus, a mode configuration in which wideband CSI is fed back and a mode configuration in which narrowband CSI is fed back. The base station apparatus can transmit a mode configuration in a narrowband CSI report (such as a mode configuration in which CSI values for all subbands are transmitted or a mode configuration in which CSI for a preferred number of subbands is transmitted). The channel state information report configuration (S202) may be the same mode configuration as the channel state information report configuration (S102) in FIG. 7.

Through the channel state information report configuration, the base station apparatus transmits, to the terminal apparatus, a mode configuration of an aperiodic channel state information report and/or a mode configuration of a periodic channel state information report. The following describes the case of a mode configuration of a periodic channel state information report.

In a case where the terminal apparatus has received information indicating a mode configuration of a periodic channel state information report, the terminal apparatus periodically transmits channel state information reports to the base station apparatus at predetermined intervals (S203 to S208). For example, the intervals at which the channel state information is reported can be signaled by the channel state information report configuration. The terminal apparatus can use resources for the PUCCH to feed back the channel state report. The intervals at which the channel state information is reported can be configured in advance by the system.

In FIG. 8, until the terminal apparatus receives the release of a mode configuration of a periodic channel state information report from the base station apparatus (S209), the terminal apparatus reports the channel state information to the base station apparatus.

For example, in a case where the channel state information report configuration (S202) is a mode configuration of a periodic channel state information report and a wideband CSI report, the terminal apparatus reports the CSI value of wideband CSI to the base station apparatus as the channel state information reports (S203 to S208).

For example, in a case where the channel state information report configuration (S202) is a mode configuration of a periodic channel state information report and a narrowband CSI report, the terminal apparatus reports the CSI value of narrowband CSI to the base station apparatus as the channel state information reports (S203 to S208).

For example, in a case where the channel state information report configuration (S202) is a mode configuration of a periodic channel state information report and wideband CSI and narrowband CSI reports, the terminal apparatus reports the CSI value of wideband CSI and the CSI value of narrowband CSI to the base station apparatus as the channel state information reports (S203 to S208).

For example, in a configuration shown in FIG. 6 in which narrowband CSI is reported and in a case where the channel state information report configuration (S202 in FIG. 7) is a mode configuration of a periodic channel state information report and wideband CSI and narrowband CSI reports, the terminal apparatus feeds back one CSI value (wideband CSI) for the system bandwidth through the channel state information report S203. Next, the terminal apparatus feeds back, through the channel state information report S204, the CSI value (narrowband CSI) of a preferred subband selected from among the subbands (#0, #1) constituting the bandwidth part #0. The terminal apparatus can transmit the subband index of the selected subband together with the channel state information report S204.

Next, the terminal apparatus feeds back, through the channel state information report 5205, the CSI value (narrowband CSI) of a preferred subband selected from among the subbands (#2, #3) constituting the bandwidth part #1. Next, the terminal apparatus again feeds back one CSI value (wideband CSI) for the system bandwidth through the channel state information report S206. Furthermore, the terminal apparatus again feeds back the CSI value of narrowband CSI in sequence through the aforementioned method (S207, S208).

Until the terminal apparatus receives the release of a mode configuration of a periodic channel state information report from the base station apparatus (S209), the terminal apparatus reports wideband CSI and narrowband CSI in sequence. In the channel state information report feedback (S203 to S208), the feedback proportion of wideband CSI to narrowband CSI may be variable. The base station apparatus can notify the terminal apparatus of the feedback proportion through the channel state information report configuration.

The following describes an example of feedback of channel state information reports for the terminal apparatuses 200-1 and 200-2 including advanced reception functions according to the present embodiment.

First, a case is described where the terminal apparatuses 200-1 and 200-2 have received information indicating that the advanced reception functions are applied.

In this case, upon receiving a channel state information report configuration (S202 of FIG. 8) indicating a mode configuration including a periodic channel state information report, the terminal apparatuses 200-1 and 200-2 follow a mode configuration in which wideband CSI or narrowband CSI is fed back and thereby report, to the base station apparatus, CSI values that are suitable in the case of reception of downlink signals without application of the advanced reception functions (S203 to S208 of FIG. 8).

Further, in a case where the channel state information report configuration (S202 of FIG. 8) indicates a mode configuration including a periodic channel state information report, upon receiving a channel state information report configuration (S102 of FIG. 7) indicating a mode configuration in which aperiodic channel state information is reported, the terminal apparatuses 200-1 and 200-2 follow a mode configuration in which wideband CSI or narrowband CSI is fed back (S103 of FIG. 7) and thereby report, to the base station apparatus, CSI values that are suitable in the case of reception of downlink signals to which the advanced reception functions have been applied (S104 of FIG. 7). The CSI values that are suitable in the case of reception of downlink signals to which the advanced reception functions have been applied need only be ones that are suitable in the case of reception of downlink signals at least one of whose CQI, RI, and PMI applies the advanced reception functions. For example, a terminal apparatus can report a CQI that is suitable in the case of reception of a downlink signal to which the advanced reception function has been applied and an RI and a PMI that are suitable in the case of reception of a downlink signal without application of the advanced reception function. The base station apparatus can configure, for each of the CQI, RI, and PMI, the case of reception of a downlink signal to which the advanced reception function has been applied or the case of reception of a downlink signal without application of the advanced reception function. The terminal apparatus can calculate the CQI, the RI, and the PMI according to the configuration of the base station apparatus.

Next, a case is described where the terminal apparatuses 200-1 and 200-2 have received information indicating that the advanced reception functions are not applied.

In this case, in a case where the terminal apparatuses 200-1 and 200-2 have received a channel state information report configuration (S202 of FIG. 8) indicating a mode configuration in which periodic channel state information reports and wideband CSI are reported, the terminal apparatuses 200-1 and 200-2 report, to the base station apparatus, CSI values of wideband CSI that are suitable in the case of reception of downlink signals without application of the advanced reception functions (S203 to S208 of FIG. 8).

Further, in a case where the channel state information report configuration (S202 of FIG. 8) indicates a mode configuration in which periodic channel state information reports and wideband CSI are reported, upon receiving a channel state information report configuration (S102 of FIG. 7) indicating a mode configuration in which aperiodic channel state information is reported, the terminal apparatuses 200-1 and 200-2 feed back, to the base station apparatus, either CSI values that are suitable in the case of reception of downlink signals with application of the advanced reception functions or CSI values that are suitable in the case of reception of downlink signals without application of the advanced reception functions. Which type of CSI value to feed back can be configured by the base station apparatus. The terminal apparatus reports a CSI value to the base station apparatus in accordance with a configuration (hereinafter also referred to as “NAICS CSI configuration”) of the base station apparatus that indicates which type of CSI to feed back (S104, S106 of FIG. 7).

The base station apparatus can transmit the NAICS CSI configuration to the terminal apparatus in an explicit or implicit manner. The NAICS CSI configuration may be incorporated into a channel state information request (S103, S105 of FIG. 7).

Further, in a case where the terminal apparatuses 200-1 and 200-2 have received information indicating that the advanced reception functions are not applied and received a channel state information report configuration (S202 of FIG. 8) indicating a mode configuration in which periodic channel state information reports and narrowband CSI are reported, the terminal apparatuses 200-1 and 200-2 report, to the base station apparatus, CSI values of narrowband CSI that are suitable in the case of reception of downlink signals without application of the advanced reception functions (S203 to S208 of FIG. 8).

Further, in a case where the channel state information report configuration (S202 of FIG. 8) indicates a mode configuration in which periodic channel state information reports and narrowband CSI are reported, upon receiving a channel state information report configuration (S102 of FIG. 7) indicating a mode configuration in which aperiodic channel state information is reported, the terminal apparatuses 200-1 and 200-2 report, to the base station apparatus, CSI values that are suitable in the case of reception of downlink signals to which the advanced reception functions have been applied (S104, S106 of FIG. 7). The foregoing makes it possible to efficiently report reception quality information in transmitting the reception quality information, and also contributes to high-accuracy interference cancellation or suppression in a case where an advanced reception function is applied.

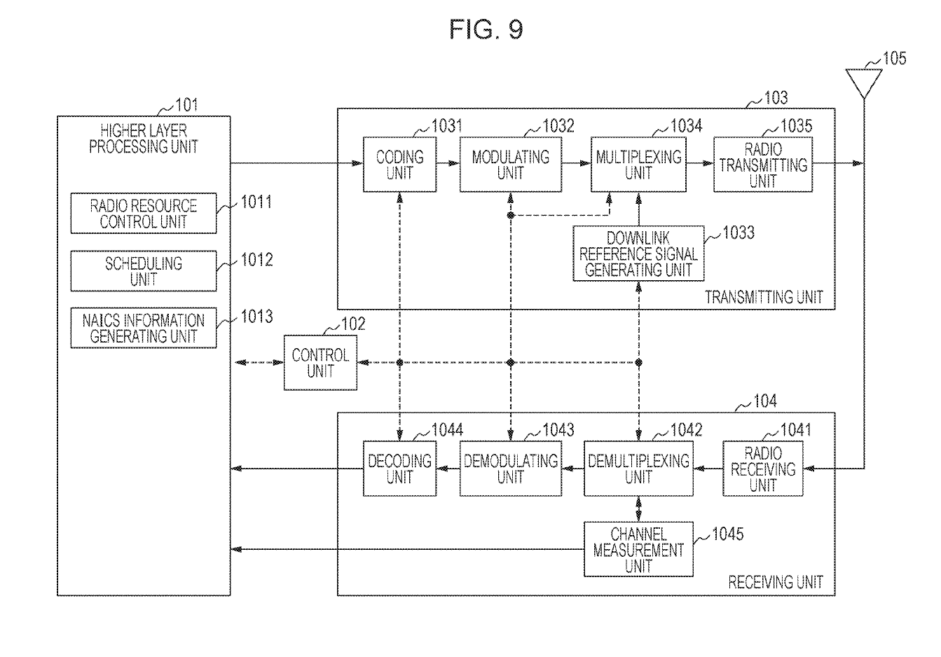

FIG. 9 is a block diagram schematically showing a configuration of a base station apparatus according to the present embodiment. The base station apparatuses 100-1 and 100-2 are base station apparatuses that can control terminal apparatuses including advanced reception functions. The following describes the base station apparatus 100-1 as a representative. As shown in FIG. 9, the base station apparatus 100-1 includes a higher layer processing unit 101, a control unit 102, a transmitting unit 103, a receiving unit 104, and a transmitting and receiving antenna 105.

The higher layer processing unit 101 includes a radio resource control unit 1011, a scheduling unit 1012, and a transmission control unit 1013. The transmitting unit 103 includes a coding unit 1031, a modulating unit 1032, a downlink reference signal generating unit 1033, a multiplexing unit 1034, and a radio transmitting unit 1035. The receiving unit 104 includes a radio receiving unit 1041, a demultiplexing unit 1042, a demodulating unit 1043, a decoding unit 1044, and a channel measurement unit 1045.

The higher layer processing unit 101 processes a medium access control (MAC) layer, a packet data convergence protocol (PDCP) layer, a radio link control (RLC) layer, a radio resource control (RRC) layer, and the like. Further, the higher layer processing unit 101 generates information that is needed to control the transmitting unit 103 and the receiving unit 104, and outputs the information to the control unit 102.

The radio resource control unit 1011 generates downlink data (transport block), system information, an RRC message, an MAC CE, and the like that are allocated on a downlink PDSCH, or acquires these pieces of information from a higher node. The radio resource control unit 1011 outputs these pieces of information to the transmitting unit 103 and outputs the other pieces of information to the control unit 102.

The radio resource control unit 1011 manages various types of configuration information/parameter of each of the terminal apparatuses (in FIG. 1, the terminal apparatus 100-1 alone) connected to the base station apparatus. The radio resource control unit 1011 may set various types of configuration information/parameter for the terminal apparatus via higher layer signals. That is, the radio resource control unit 1011 transmits/broadcasts information indicating various types of configuration information/parameter.

Configuration information of an interfering terminal apparatus may be incorporated into the various types of configuration information/parameter in the radio resource control unit 1011. The base station apparatus is configured to be able to acquire the configuration information of an interfering terminal apparatus from the configuration information of a terminal apparatus connected to the base station apparatus.

The radio resource control unit 1011 can acquire, from the receiving unit 104, information indicating that the terminal apparatus includes an advanced reception function. The information indicating that the terminal apparatus includes an advanced reception function may be incorporated into the UE capability. The radio resource control unit 1011 can also incorporate, into the information indicating that the terminal apparatus includes an advanced reception function, a scheme for canceling or suppressing an interfering signal. The radio resource control unit 1011 can acquire, from the receiving unit 104, information pertaining to a channel state information report.

The radio resource control unit 1011 can generate information pertaining to the application of the advanced reception function and output the information to the transmitting unit 103. The radio resource control unit 1011 can generate a channel state information report configuration and output it to the transmitting unit 103. The radio resource control unit 1011 can generate a channel state information request and output it to the transmitting unit 103. The radio resource control unit 1011 can generates a configuration indicating whether to feed back a CSI value of wideband CSI that is suitable in the case of reception of a downlink signal to which the advanced reception function has been applied or a CSI value of wideband CSI that is suitable in the case of reception of a downlink signal without application of the advanced reception function and output the configuration to the transmitting unit 103.

The radio resource control unit 1011 can generate information (such as the system information, RNTI, MCS, RI, and PMI of the interfering signal to be suppressed) that is needed to cancel or suppress the interfering signal (e.g. a signal transmitted from the base station apparatus 100-2 and received by the terminal apparatus 200-1 or a stream signal in SU-MIMO) and output the information to the transmitting unit 103. It should be noted that the information that is need to cancel/suppress the interfering signal can be acquired from another base station apparatus (e.g. an X2 interface, an Internet line, or the like).

The scheduling unit 1012 determines, from received channel state information (CSI), an estimated value of a channel or the quality of a channel as inputted from the channel measurement unit 1045, and the like, frequencies and subframes to which physical channels (such as a PDSCH and a PUSCH) are assigned, code rates and modulation schemes (or MCSs) of the physical channels, transmission powers, and the like. On the basis of a scheduling result, the scheduling unit 1012 generates control information for controlling the receiving unit 104 and the transmitting unit 103. The scheduling unit 1012 outputs the information thus generated to the control unit 102. The scheduling unit 1012 determines timings at which a transmitting process and a receiving process are performed.

The transmission control unit 1013 controls the transmitting unit 103 to map the PDSCH onto resource elements on the basis of the RNTI used in the scrambling of CRC parity bits appended to the downlink control information and perform transmission through the PDSCH. Note here that the function of the transmission control unit 1013 may be included in the transmitting unit 103.

The control unit 102 generates, on the basis of the information inputted from the higher layer processing unit 101, control signals in accordance with which the transmitting unit 103 and the receiving unit 104 are controlled. The control unit 102 generates downlink control information on the basis of the information inputted from the higher layer processing unit 101 and outputs the downlink control information to the transmitting unit 103.

The control unit 102 can acquire, from the receiving unit 104, information indicating that the terminal apparatus includes an advanced reception function. The radio resource control unit 1011 can acquire, from the receiving unit 104, information pertaining to a channel state information report. The control unit 102 can input the information thus acquired to the higher layer processing unit 101.

The control unit 102 can incorporate, into the downlink control information, information pertaining to the application of the advanced reception function. The control unit 102 can incorporate a channel state information report configuration into the downlink control information. The control unit 102 can incorporate a channel state information request into the downlink control information. The control unit 102 can incorporate, into the downlink control information, a configuration indicating whether to feed back a CSI value of wideband CSI that is suitable in the case of reception of a downlink signal to which the advanced reception function has been applied or a CSI value of wideband CSI that is suitable in the case of reception of a downlink signal without application of the advanced reception function.

The control unit 102 can generate, in the downlink control information, information (such as the system information, RNTI, MCS, RI, and PMI of the interfering signal to be suppressed) that is needed to cancel or suppress the interfering signal and output the information to the transmitting unit 103. It should be noted that the information that is need to cancel/suppress the interfering signal can be acquired from another base station apparatus (e.g. an X2 interface, an Internet line, or the like).

In accordance with the control signal inputted from the control unit 102, the transmitting unit 103 generates a downlink reference signal, codes and modulates the HARQ indicator, the downlink control information, and the downlink data, which were inputted from the higher layer processing unit 101, multiplexes the PHICH, the PDCCH, the EPDCCH, the PDSCH, and the downlink reference signal, and transmits the multiplexed signals to the terminal apparatus 200-1 via the transmitting and receiving antenna 105.

The coding unit 1031 codes the HARQ indicator, the downlink control information, and the downlink data, which were inputted from the higher layer processing unit 101, under a predetermined coding scheme such as block coding, convolutional coding, or turbo coding. The coding unit 1031 performs coding under a coding scheme determined by the radio resource control unit 1011. The modulating unit 1032 receives coding bits from the coding unit 1031 and modulates the coding bits under a predetermined modulation scheme such as BPSK (binary phase shift keying), QPSK (quadrature phase shift keying), 16QAM (quadrature amplitude modulation), 64QAM, or 256QAM or under a modulation scheme determined by the radio resource control unit 1011.

On the basis of a physical cell identity (PCI) or the like for identifying the base station apparatus 100-1, the downlink reference signal generating unit 1033 generates, as the downlink reference signal, a sequence known by the terminal apparatus 2 that is determined according to a predetermined rule.

The multiplexing unit 1034 multiplexes a modulation symbol of each channel modulated, the downlink reference signal thus generated, and the downlink control information thus generated. That is, the multiplexing unit 1034 allocates the modulation symbol of each channel modulated, the downlink reference signal, and the downlink control information on a resource element.

The radio transmitting unit 1035 performs inverse fast Fourier transform (IFFT) on the modulation symbols and the like thus multiplexed, generates an OFDM symbol, appends a cyclic prefix (CP) to the OFDM symbol, generates a baseband digital signal, converts the baseband digital signal into an analog signal, eliminates an excess frequency component through filtering, up-converts the analog signal into a carrier frequency, performs power amplification, and outputs the analog signal to the transmitting and receiving antenna 105.

In accordance with the control signal inputted from the control unit 102, the receiving unit 104 demultiplexes, demodulates, and decodes a received signal received from the terminal apparatus 200-1 via the transmitting and receiving antenna 105 and outputs decoded information to the higher layer processing unit 101.

The radio receiving unit 1041 down-converts, into a baseband signal, an uplink signal received via the transmitting and receiving antenna 105, eliminates an unwanted frequency component, controls the amplification level so that the signal level is appropriately maintained, performs orthogonal demodulation on the basis of an in-phase component and an orthogonal component of the received signal, and converts the orthogonally-demodulated analog signal into a digital signal.

The radio receiving unit 1041 eliminates, from the digital signal thus converted, a portion corresponding to the CP. The radio receiving unit 1041 performs fast Fourier transform (FFT) on the signal from which the CP has been eliminated, extracts a frequency-domain signal, and outputs the frequency-domain signal to the demultiplexing unit 1042.

The demultiplexing unit 1042 demultiplexes the signal inputted from the radio receiving unit 1041 into signals such as the PUCCH, the PUSCH, and the uplink reference signal. It should be noted that this demultiplexing is performed on the basis of radio resource allocation information contained in an uplink grant determined in advance by the radio resource control unit 1011 of the base station apparatus 100-1 and notified to each terminal apparatus 200-1. Further, the demultiplexing unit 1042 makes compensations for the channels of the PUCCH and the PUSCH from estimated values of the channels as inputted from the channel measurement unit 1045. Further, the demultiplexing unit 1042 output the uplink reference signal thus separated to the channel measurement unit 1045.

The demodulating unit 1043 performs inverse discrete Fourier transform (IDFT) on the PUSCH, acquires the modulation symbols, and performs demodulation of the received signal on each of the modulation symbols of the PUCCH and the PUSCH under a modulation scheme such as BPSK, QPSK, 16QAM, 64QAM, or 256QAM or under a modulation scheme notified in advance by the base station apparatus to each terminal apparatus 2 through the uplink grant.

The decoding unit 1044 decodes the coding bits of the PUCCH and the PUSCH thus demodulated. This decoding is performed under a predetermined coding scheme and at predetermined coding rates or coding rates notified in advance by the base station apparatus 1 to the terminal apparatus 2 through the uplink grant. The decoding unit 1044 outputs the uplink data thus decoded and the uplink control information to the higher layer processing unit 101. In the case of retransmission of the PUSCH, the decoding unit 1044 performs decoding using coding bits retained in an HARQ buffer that is inputted from the higher layer processing unit 101 and the coding bits thus demodulated.

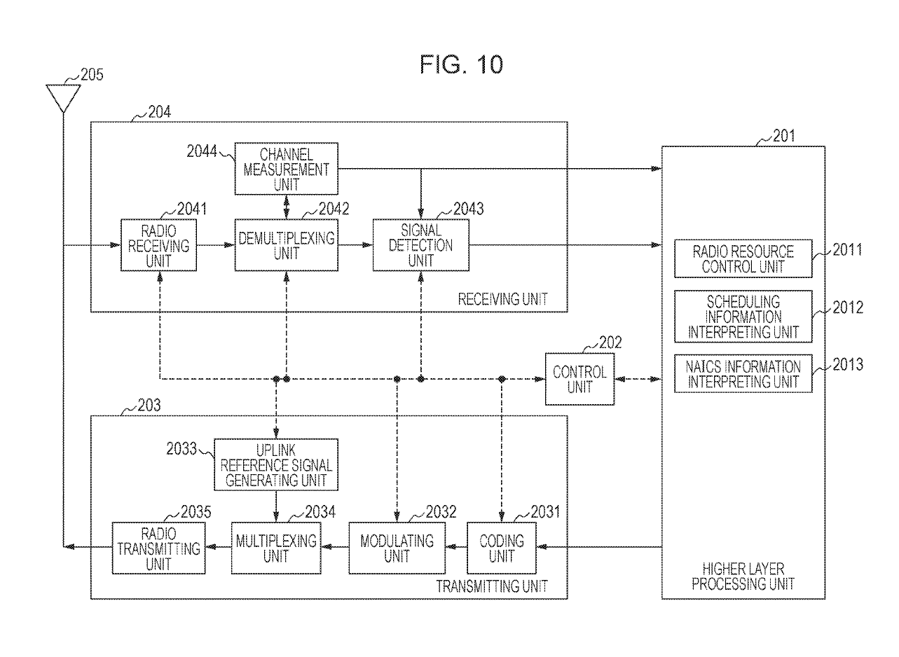

FIG. 10 is a block diagram schematically showing a terminal apparatus including an advanced reception function according to the present embodiment. The base station apparatuses 200-1 and 200-2 are terminal apparatuses including advanced reception functions. The following describes the terminal apparatus 200-1 as a representative.

As shown in FIG. 9, the terminal apparatus 200-1 includes a higher layer processing unit 201, a control unit 202, a transmitting unit 203, a receiving unit 204, and a transmitting and receiving antenna 205. The higher layer processing unit 201 includes a radio resource control unit 2011, a scheduling information interpreting unit 2012, and a reception control unit 2013.

The transmitting unit 203 includes a coding unit 2031, a modulating unit 2032, an uplink reference signal generating unit 2033, a multiplexing unit 2034, and a radio transmitting unit 2035. The receiving unit 204 includes a radio receiving unit 2041, a demultiplexing unit 2042, a signal detection unit 2043, and a channel measurement unit 2044.

The higher layer processing unit 201 outputs, to the transmitting unit 203, uplink data (transport block) generated by a user's operation or the like. Further, the higher layer processing unit 201 processes a medium access control (MAC) layer, a packet data convergence protocol (PDCP) layer, a radio link control (RLC) layer, and a radio resource control (RRC) layer.

The radio resource control unit 2011 manages various types of configuration information/parameter of the terminal apparatus. The radio resource control unit 2011 sets various types of configuration information/parameter on the basis of higher layer signals (e.g. RRC Signaling and MAC CE) received from the base station apparatus 100-1. The radio resource control unit 2011 generates information that is allocated to each uplink channel and outputs the information to the transmitting unit 203.

The radio resource control unit 2011 can acquire, from the receiving unit 204, information pertaining to the application of the advanced reception function. The radio resource control unit 2011 can acquire a channel state information report configuration from the receiving unit 204. The radio resource control unit 2011 can acquire a channel state information request from the receiving unit 204. The radio resource control unit 2011 can acquire information (such as the system information, RNTI, MCS, RI, and PMI of the interfering signal to be suppressed) that is needed to cancel or suppress the interfering signal.

The radio resource control unit 2011 can generate information indicating that the terminal apparatus includes an advanced reception function and output the information to the transmitting unit 203. The radio resource control unit 1011 can incorporate, into the information indicating that the terminal apparatus includes an advanced reception function, a scheme for canceling or suppressing an interfering signal. The radio resource control unit 2011 can generate a channel state information report according to the information pertaining to the application of the advanced reception function/the channel state information report configuration/the channel state information request and output the channel state information report to the transmitting unit 203. The radio resource control unit 2011 can input the information thus acquired to the receiving unit 204.

The scheduling information interpreting unit 2012 interprets downlink control information (DCI format, scheduling information) received via the receiving unit 204. The scheduling information interpreting unit 2012 generates, on the basis of a result of the interpretation of the DCI format, control information for controlling the receiving unit 204 and the transmitting unit 203 and outputs the control information to the control unit 202.

The reception control unit 2013 identifies subframes on the basis of the RNTI used in the scrambling of the CRC parity bits appended to the downlink control information and controls the receiving unit 204 to decode the PDSCH on the basis of the subframes thus identified. Note here that the function of the reception control unit 2013 may be included in the receiving unit 204.

The control unit 202 generates, on the basis of the information inputted from the higher layer processing unit 201, control signals in accordance with which the receiving unit 204 and the transmitting unit 203 are controlled. The control unit 202 outputs the control signals thus generated to the receiving unit 204 and the transmitting unit 203 to control the receiving unit 204 and the transmitting unit 203.

The control unit 202 can acquire, from the receiving unit 204, information pertaining to the application of the advanced reception function. The control unit 202 can acquire a channel state information report configuration from the receiving unit 204. The radio resource control unit 2011 can acquire a channel state information request from the receiving unit 204. The control unit 202 can acquire information (such as the system information, RNTI, MCS, RI, and PMI of the interfering signal to be suppressed) that is needed to cancel or suppress the interfering signal from the receiving unit 204. The control unit 102 can input the information thus acquired to the higher layer processing unit 201 and the receiving unit 204.

The control unit 202 can generate information indicating that the terminal apparatus includes an advanced reception function and output the information to the transmitting unit 203. The radio resource control unit 1011 can incorporate, into the information indicating that the terminal apparatus includes an advanced reception function, a scheme for canceling or suppressing an interfering signal. The radio resource control unit 2011 can generate a channel state information report according to the information pertaining to the application of the advanced reception function/the channel state information report configuration/the channel state information request and output the channel state information report to the transmitting unit 203.

On the basis of the information pertaining to the application of the advanced reception function/the channel state information report configuration/the information that is needed to cancel or suppress the interfering signal, the control unit 202 can control the receiving unit 204 to go so far as to demodulate the interfering signal. On the basis of the information pertaining to the application of the advanced reception function/the information that is needed to cancel or suppress the interfering signal, the control unit 202 can control the receiving unit 204 to go so far as to decode the interfering signal.

In accordance with the control signal inputted from the control unit 202, the receiving unit 204 demultiplexes, demodulates, and decodes a received signal received from the base station apparatus 100-1 via the transmitting and receiving antenna 205 and outputs decoded information to the higher layer processing unit 201.

The radio receiving unit 2041 down-converts, into a baseband signal, a downlink signal received via the transmitting and receiving antenna 205, eliminates an unwanted frequency component, controls the amplification level so that the signal level is appropriately maintained, performs orthogonal demodulation on the basis of an in-phase component and an orthogonal component of the received signal, and converts the orthogonally-demodulated analog signal into a digital signal. The radio receiving unit 2041 eliminates, from the digital signal thus converted, a portion corresponding to the CP, performs fast Fourier transform on the signal from which the CP has been eliminated, and extracts a frequency-domain signal.

The demultiplexing unit 2042 demultiplexes the extracted signal into the PHICH, the PDCCH, the EPDCCH, the PDSCH, and the downlink reference signal. Further, the demultiplexing unit 2042 makes compensations for the channels of the PHICH, the PDCCH, and the EPDCCH on the basis of channel estimation values of desired signals as inputted from the channel measurement unit 2044, detects the downlink control information, and outputs the downlink control information to the control unit 202. Further, the control unit 202 outputs the PDSCH and the channel estimation values of the desired signals to the signal detection unit 2043. The demultiplexing unit 2042 outputs the downlink reference signal thus separated to the channel measurement unit 2044.

The channel measurement unit 2044 performs a channel estimation of the interfering signal. The channel estimation of the interfering signal can be performed using the downlink reference signal. The channel measurement unit 2044 outputs a channel estimated value of the interfering signal to the signal detection unit 2043.

The signal detection unit 2043 detects, with reference to the PDSCH, the channel estimation values, and the information pertaining to the application of the advanced reception function/the information that is needed to cancel or suppress the interfering signal, the downlink data (transport block) of a terminal apparatus connected to the base station apparatus, and outputs the downlink data to the higher layer processing unit 201.

In a case where the signal detection unit 2043 has acquired information indicating that the advanced reception function is applied, the signal detection unit 2043 cancels or suppresses the interfering signal with use of the advanced reception function. Examples of the method for canceling or suppressing the interfering signal include linear detection, maximum likelihood estimation, interference cancellers, and the like. Examples of linear detection include LMMSE-IRC (linear minimum mean square error-interference rejection combining), Enhanced LMMSE-IRC, WLMMSE-IRC (widely linear MMSE-IRC), and the like. Examples of maximum likelihood estimation includes ML (maximum likelihood), R-ML (reduced complexity ML), iterative ML, iterative R-ML, and the like. Examples of interference cancellers include turbo SIC (successive interference cancellation), PIC (parallel interference cancellation), L-CWIC (linear code word level SIC), ML-CWIC (ML code word level SIC), SLIC (symbol level IC), and the like.

In accordance with the control signal inputted from the control unit 202, the transmitting unit 203 generates an uplink reference signal, codes and modulates the uplink data (transport block) inputted from the higher layer processing unit 201, multiplexes the PUCCH, the PUSCH, and the uplink reference signal thus generated, and transmits the multiplexed signals to the base station apparatus 100-1 via the transmitting and receiving antenna 205.

The coding unit 2031 receives uplink control information from the higher layer processing unit 201 and codes the uplink control information by convolutional coding, block coding, or the like. Further, the coding unit 2031 performs turbo coding on the basis of information that is used in the scheduling of the PUSCH.

The modulating unit 2032 receives coding bits from the coding unit 2031 and modulates the coding bits under a predetermined modulation scheme such as BPSK, QPSK, 16QAM, or 64QAM notified through the downlink control information or under a modulation scheme determined for each channel.

On the basis of a physical cell identifier (referred to as “physical cell identity: PCI”, “cell ID”, or the like) for identifying the base station apparatus 100-1, a bandwidth on which the uplink reference signal is allocated, a cyclic shift notified through an uplink grant, the values of parameters in the generation of a DMRS sequence, the uplink reference signal generating unit 2033 generates a sequence that is determined by a predetermined rule (formula).

In accordance with the control signal inputted from the control unit 202, the multiplexing unit 2034 sorts the modulation symbols of the PUSCH in parallel and then performs discrete Fourier transform (DFT) on the modulation symbols. Further, the multiplexing unit 2034 multiplexes, for each transmitting antenna port, the signals of the PUCCH and the PUSCH and the uplink reference signal thus generated. That is, the multiplexing unit 2034 allocates, on a resource element for each transmitting antenna port, the signals of the PUCCH and the PUSCH and the uplink reference signal thus generated.

The radio transmitting unit 2035 performs inverse fast Fourier transform (IFFT) on the multiplexed signals, performs modulation under an SC-FDMA scheme to generate an SC-FDMA symbol, appends a CP to the SC-FDMA symbol thus generated, generates a baseband digital signal, eliminates an excess frequency component through filtering, up-converts the analog signal into a carrier frequency, performs power amplification, and outputs the analog signal to the transmitting and receiving antenna 205.

It should be noted that the terminal apparatus 200-3, which includes no advanced reception function, includes MMSE detection or the like instead of linear detection, maximum likelihood estimation, an interference canceller, or the like in the signal detection unit 2043.

As noted above, an edge including an advanced reception function can report reception quality information with less increase in feedback amount of reception quality information reports than a terminal apparatus including no advanced reception function. This makes it possible to cancel or suppress interference while suppressing an increase in the feedback amount.

A program that runs on a base station apparatus and a mobile station apparatus according to the present invention is a program that controls a CPU or the like (i.e., a program that causes a computer to function) so that the functions of the above-described embodiment of the present invention are achieved. Moreover, information that is handled by these apparatuses is temporarily accumulated in RAM during processing thereof, stored in various types of ROM and/or HDD after that, and read out by the CPU as needed for modification and/or writing. Examples of a storage medium in which the program is stored may include semiconductor media (such as ROM and nonvolatile memory cards), optical storage media (such as DVDs, MOs, MDs, CDs, and BDs), magnetic storage media (such as magnetic tapes and flexible disks). Further, not only are the functions of the embodiment described above achieved by executing the program loaded, but also the functions of the present invention may be achieved by executing processing in cooperation with an operating system or another application program on the basis of instructions from the program.

Further, the program can be distributed to the market by being stored in a portable storage medium or being transferred to a server computer connected via a network such as the Internet. In this case, a storage device of the server computer is also encompassed in the present invention. Further, one, some, or all of the base station apparatus and the terminal apparatus in the embodiment described above may be achieved as an LSI that is typically an integrated circuit. Each functional block of the receiving apparatus may separately take the form of a chip, or one, some, or all of them may be integrated into a chip. In a case where each functional block is integrated into a circuit, an integrated circuit control unit that controls them is added.

Further, the technique of circuit integration may be achieved by a dedicated circuit or a general-purpose processor, as well as an LSI. Further, in a case where a technology of integrated circuit construction alternative to LSI comes out due to the advancement of technology, it is possible to use integrated circuits based on such a technology.

It should be noted that the present invention is not limited to the embodiment described above. A terminal apparatus of the present invention is not limited to being applied to a mobile station apparatus, and is of course applicable to stationary or immovable electronic devices that are installed indoors or outdoors such as audiovisual equipment, kitchen appliances, cleaning and washing machines, air-conditioning equipment, office devices, vending machines, and other domestic appliances.

Although an embodiment of the present invention has been described in detail above with reference to the drawings, a specific configuration is not limited to this embodiment, and designs and the like are also encompassed in the patent claims, provided such designs and the like do not depart from the spirit of the present invention.

### INDUSTRIAL APPLICABILITY

The present invention is suitably applicable to a terminal apparatus, a base station apparatus, a communication system, a receiving method, a transmitting method, and a communication method.

The present disclosure contains subject matter related to that disclosed in Japanese Priority Patent Application JP 2014-057385 filed in the Japan Patent Office on Mar. 20, 2014, the entire contents of which are hereby incorporated by reference.

### REFERENCE SIGNS LIST

100-1, 100-2 Base station apparatus
200-1, 200-2, 200-3 Terminal apparatus
101 Higher layer processing unit
102 Control unit
103 Transmitting unit
104 Receiving unit
105 Transmitting and receiving antenna
1011 Radio resource control unit
1012 Scheduling unit
1013 Transmission control unit
1031 Coding unit
1032 Modulating unit
1033 Downlink reference signal generating unit
1034 Multiplexing unit
1035 Radio transmitting unit
1041 Radio receiving unit
1042 Demultiplexing unit
1043 Demodulating unit
1044 Decoding unit
1045 Channel measurement unit
201 Higher layer processing unit
202 Control unit
203 Transmitting unit
204 Receiving unit
205 Transmitting and receiving antenna
2011 Radio resource control unit
2012 Scheduling information interpreting unit
2013 Reception control unit
2031 Coding unit
2032 Modulating unit
2033 Uplink reference signal generating unit
2034 Multiplexing unit
2035 Radio transmitting unit
2041 Radio receiving unit
2042 Demultiplexing unit
2043 Signal detection unit
2044 Channel measurement unit

1. A terminal apparatus comprising:
a receiving unit that receives information pertaining to a network assisted interference cancellation function, a channel state information request, and information pertaining to a channel state information report configuration; and
a transmitting unit that transmits channel state information report feedback constituted by a given number of channel state information values corresponding to the information pertaining to the channel state information report configuration and the channel state information request,
wherein the information pertaining to the channel state information report configuration includes a mode configuration in which channel state information is periodically reported and a mode configuration in which channel state information is aperiodically reported,
channel state information values corresponding to the mode configuration in which channel state information is periodically reported are channel state information values that are suitable in a case of reception of a downlink signal without application of the network assisted interference cancellation function, and
channel state information values that are suitable in a case of reception of a downlink signal with application of the network assisted interference cancellation function are channel state information values that are transmitted in the mode configuration in which channel state information is aperiodically reported.

2. The terminal apparatus according to claim 1, wherein in a case where the information pertaining to the network assisted interference cancellation function is information indicating that the function is applied, channel state information values corresponding to the mode configuration in which channel state information is aperiodically reported are channel state information values that are suitable in the case of reception of a downlink signal with application of the network assisted interference cancellation function.

3. The terminal apparatus according to claim 1, wherein in a case where the information pertaining to the network assisted interference cancellation function is information indicating that the function is not applied and where the mode configuration in which channel state information is periodically reported is a mode in which wideband channel state information is reported, channel state information values corresponding to the mode configuration in which channel state information is aperiodically reported are selected from among either channel state information values that are suitable in the case of reception of a downlink signal without application of the network assisted interference cancellation function or the channel state information values that are suitable in the case of reception of a downlink signal with application of the network assisted interference cancellation function.

4. The terminal apparatus according to claim 3, wherein the channel state information request contains instructions for a request for the channel state information values that are suitable in the case of reception of a downlink signal without application of the network assisted interference cancellation function and a request for the channel state information values that are suitable in the case of reception of a downlink signal with application of the network assisted interference cancellation function, and
the channel state information values corresponding to the mode configuration in which channel state information is aperiodically reported are selected according to the channel state information request.

5. The terminal apparatus according to claim 3, wherein in a case where the information pertaining to the network assisted interference cancellation function is information indicating that the function is not applied and where the mode configuration in which channel state information is periodically reported is a mode in which narrowband channel state information is reported, the channel state information values corresponding to the mode configuration in which channel state information is aperiodically reported are the channel state information values that are suitable in the case of reception of a downlink signal with application of the network assisted interference cancellation function.

6. The terminal apparatus according to claim 6, wherein the receiving unit receives information indicating a scheme for modulating an interfering signal,
the terminal apparatus further comprising a signal detection unit that cancels or suppresses the interfering signal with use of the information indicating the scheme for modulating the interfering signal.

7. The terminal apparatus according to claim 6, wherein the receiving unit receives information indicating a rank of an interfering signal,
the terminal apparatus further comprising a signal detection unit that demultiplexes a spatially multiplexed signal with use of the information indicating the rank of the interfering signal.

8. A base station apparatus comprising:
a transmitting unit that transmits information pertaining to a network assisted interference cancellation function, a channel state information request, and information pertaining to a channel state information report configuration; and
a receiving unit that receives channel state information report feedback constituted by a given number of channel state information values corresponding to the information pertaining to the channel state information report configuration and the channel state information request,
wherein the information pertaining to the channel state information report configuration includes a mode configuration in which channel state information is periodically reported and a mode configuration in which channel state information is aperiodically reported,
channel state information values corresponding to the mode configuration in which channel state information is periodically reported are channel state information values that are suitable in a case of reception of a downlink signal without application of the network assisted interference cancellation function, and
channel state information values that are suitable in a case of reception of a downlink signal with application of the network assisted interference cancellation function are channel state information values that are transmitted in the mode configuration in which channel state information is aperiodically reported.

9. The base station apparatus according to claim 8, wherein in a case where the information pertaining to the network assisted interference cancellation function is information indicating that the function is applied, channel state information values corresponding to the mode configuration in which channel state information is aperiodically reported are the channel state information values that are suitable in the case of reception of a downlink signal with application of the network assisted interference cancellation function.

10. The base station apparatus according to claim 8, wherein in a case where the information pertaining to the network assisted interference cancellation function is information other than information indicating that the function is applied and where the mode configuration in which channel state information is periodically reported is a mode in which wideband channel state information is reported, the channel state information request contains instructions for a request for the channel state information values that are suitable in the case of reception of a downlink signal without application of the network assisted interference cancellation function and a request for the channel state information values that are suitable in the case of reception of a downlink signal with application of the network assisted interference cancellation function.

11. The base station apparatus according to claim 8, wherein in a case where the information pertaining to the network assisted interference cancellation function is information other than information indicating that the function is applied and where the mode configuration in which channel state information is periodically reported is a mode in which narrowband channel state information is reported, channel state information values corresponding to the mode configuration in which channel state information is aperiodically reported are the channel state information values that are suitable in the case of reception of a downlink signal with application of the network assisted interference cancellation function.
